(19) United States
(12) Patent Application Publication
(10) Pub. No.: US 2024/0211215 A1
(43) Pub. Date: Jun. 27, 2024

(54) SYSTEM, METHOD AND COMPUTER PROGRAM FOR MANAGING STYLISTIC DESIGN IN APPLICATION BUILDER

(71) Applicant: AQUAFADAS S.A.S.U., Montpellier (FR)

(72) Inventors: Christelle DUCLOS, Montpellier (FR); Tiffany VISSOUZE, Montpellier (FR)

(73) Assignee: AQUAFADAS S.A.S.U., Montpellier (FR)

(21) Appl. No.: 18/087,306

(22) Filed: Dec. 22, 2022

(51) Int. Cl. G06F 8/34; G06F 3/0484; G06F 8/20

(52) U.S. Cl. CPC G06F 8/34; G06F 3/0484; G06F 8/20

(57) ABSTRACT

Provided are apparatus, system, method, and device for managing a testing in a marketplace. The apparatus includes: at least one memory storage storing computer-executable instructions; and at least one processor communicatively coupled to the memory storage, wherein the at least one processor is configured to execute the computer-executable instructions to: present, to a user, a first graphical user interface (GUI) comprising information of a stylistic category; receive, from the user via the first GUI, a user input for managing a customized design option associated with the stylistic category; and manage the customized design option based on the user input.

### BACKGROUND

### 1. Field

Systems, apparatuses and methods consistent with example embodiments of the present disclosure relate to application builders, more particularly, to stylistic design management in low-code or no-code application builders.

### 2. Description of Related Art

In the related art, a low-code or no-code application builder (may be referred to as “App builder” hereinbelow) is a platform or system which allows a user, who may not have experience or skill in coding, to build an application by, for example, configuring and selecting templates (e.g., pre-configured functional components, pre-defined stylistic design options, etc.) from a graphical user interface (GUI).

For instance, an App builder may include pre-configured functional components, such as (but are not limited to) buttons, sliders, and the like, so as to allow a user to build an application by, for example, drag-and-drop of desired functional components, with simplicity. Similarly, the App builder may also include pre-defined stylistic design options, such as (but are not limited to) pre-defined color design options, pre-defined typography design option, and the like, so as to allow the user to configure the stylistic design of the application by, for example, selecting the available design options.

Nevertheless, as discussed hereinbelow, the stylistic design related features in the related art App builder are restricted and the stylistic design of an application is difficult to be managed in the related art.

To begin with, in the related art, the selectable or available stylistic design options (e.g., color, typography, etc.) are defined by a design charter provided by a specific user (e.g., a developer of App builder, a manager or system admin of the App builder, etc.). Thus, the selectable stylistic design options may be generic and the users of the App builder may have limited choice on the stylistic design, which may be troublesome particularly when the users would like to have a specific stylistic design applied when building an application with the App builder (e.g., a user may want to utilize a specific color X in his application, but the App builder only have color options A-C available, etc.).

In case a user's desired design option is not available, the user may need to (1) contact the provider of the design charter (may be referred to as “charter provider” hereinafter) and request the charter provider to modify the design charter (e.g., add new design option, adjust previously-set design option, etc.) according to the user's desired design requirements, or (2) modify the design charter by himself or herself to introduce or include the desired design option.

In this regard, approach (1) may be time consuming since the to-and-fro communication between the user and the charter provider may be inefficient (e.g., charter provider may not quickly grasp the user's desired design requirement and may deliver incorrect charter changes at the first attempt, etc.) and may eventually cause delay in building and completing the application. On the other hand, approach (2) requires the user to have prerequisite knowledge and skills (e.g., knowledge on how to configure the design charter, coding skills, etc.). Further, said approach (2) requires the user to manually modify the design charter, which may introduce human error.

In addition, in the related art, since the design charter is shared and utilized by all users of the App builder, an error made in the design charter will eventually affect all users (e.g., an operational error caused by error in design charter would be applicable to all users, etc.). Further, a modification made by a user may not be intended by another user. For example, a first user may modify the design charter to change a pre-defined design option, but a second user may not want the pre-defined design option to be modified in the way the first user has done.

On the other hand, the user may want to share a specific design option to only a specific user(s), and may want to avoid other user(s) to view or utilize the specific design option. For instance, a first user may want to share with a second user a font color design 1, and may want to share with a third user a font color design 2, but would like to avoid the second user to view or utilize font color design 2 and/or to avoid the third user to view or utilize font color design 1. Nevertheless, in the related, since the inclusion of user's intended design options are performed on the design charter (which is shared and utilized among all users), it will be unduly difficult (if not impossible) for the user to share a specific design option to only a specific user(s).

Furthermore, in the related art, after modifying the design charter to adjust a design option, the user (e.g., the change requestor, the charter provider, etc.) may need to manually update all application design which has involved the old design option to appropriately reflect the adjusted design option. For instance, a first user may have applied a typography design 1 in 10 applications, and may modified the design charter to adjust a font size in typography design 1. In that case, the first user may need to manually update the 10 applications (e.g., by modifying the source codes associated therewith, etc.) to reflect the adjusted font size therein. Such an approach is burdensome for the user, requires the user to have good knowledge and coding skills, and may easily introduce errors.

### SUMMARY

Example embodiments of the present disclosure provide a system, apparatus, and method for improving the introduction or inclusion of a user's desired stylistic design option in a low-code or no-code application builder. Further, example embodiments of the present disclosure may allow the user to easily customize, adjust, modify, and/or share a design option, without affecting the design charter utilized by all users while avoiding disclosing the design option to non-associated users. Furthermore, example embodiments of the present disclosure may automatically reflect an update in a design whenever a user has modified or adjusted the associated design option.

Ultimately, example embodiments of the present disclosure simplify the processes of and reduce the user's burden in managing stylistic design in the low-code or no-code application builder, provide a user friendly approach to include or adjust a design option via one or more GUIs, improve operational stability by reducing human error, increase efficiency by omitting to-and-fro communication among users, automatically reflect user's update of stylistic design in the associated applications or projects, and improve work efficiency while avoid leakage of sensitive information by allowing sharing of one or more design options among specific users.

According to embodiments, an apparatus including: at least one memory storage storing computer-executable instructions; and at least one processor communicatively coupled to the memory storage, wherein the at least one processor may be configured to execute the computer-executable instructions to: present, to a user, a first graphical user interface (GUI) including information of a stylistic category; receive, from the user via the first GUI, a user input for managing a customized design option associated with the stylistic category; and manage the customized design option based on the user input.

The stylistic category may be a color category. Alternatively, the stylistic category may be a typography category.

The at least one processor may be configured to execute the computer-executable instructions to present the first GUI by: obtaining at least one source design charter associated with the stylistic category; generating a listing including at least one design option predefined by the source design charter; generating, based on the listing, the first GUI; and providing the first GUI to a user terminal associated with the user.

The first GUI may include a plurality of interactive elements, each of which may be associated with an operation for managing the customized design option, wherein the user input may include a user interaction with at least one interactive element of the plurality of interactive elements, and wherein the at least one processor may be configured to execute the computer-executable instructions to manage the customized design option by: determining, based on the user input, the operation associated with the interactive element with which the user has interacted; and performing the operation to manage the customized user input.

The at least one processor may be further configured to execute the computer-executable instructions to manage the customized design option by: based on determining that the operation is a creation of a new customized design option, presenting, to the user, a second GUI including one or more interactive elements for specifying the configuration of the new customized design option; receiving, from the user via the second GUI, a user interaction with the one or more interactive elements; generating, based on the user interaction, a new customized design charter, wherein the new customized design charter may define the user-specified configuration of the new customized design option; and updating, based on the new customized design charter, the first GUI to include information associated with the new customized design option.

The at least one processor may be further configured to execute the computer-executable instructions to manage the customized design option by: based on determining that the operation is a modification of an existing customized design option, presenting, to the user, a second GUI including information associated with the existing customized design option and one or more interactive elements for modifying the existing customized design option; receiving, from the user via the second GUI, a user interaction with the one or more interactive elements; updating, based on the user interaction, a customized design charter associated with the existing customized design option, wherein the updated customized design charter may define a modified customized design option; and updating, based on the updated customized design charter, the first GUI to include information associated with the modified customized design option.

The at least one processor may be further configured to execute the computer-executable instructions to manage the customized user input by: based on determining that the operation is a sharing of an existing customized design option, presenting, to the user, a second GUI including information associated with the existing customized design option and one or more interactive elements for specifying at least one user to which the existing customized design option should be shared; receiving, from the user via the second GUI, a user interaction with the one or more interactive elements; obtaining, based on the user interaction, at least one configuration profile associated with the at least one user; and updating the at least one configuration profile to include an ID of a customized design charter associated with the existing customized design option.

According to embodiments, a method, performed by at least one processor, including: presenting, to a user, a first graphical user interface (GUI) including information of a stylistic category; receiving, from the user via the first GUI, a user input for managing a customized design option associated with the stylistic category; and managing the customized design option based on the user input.

The stylistic category may be a color category. Alternatively, the stylistic category may be a typography category.

The presenting of the first GUI may include: obtaining at least one source design charter associated with the stylistic category; generating a listing including at least one design option predefined by the source design charter; generating, based on the listing, the first GUI; and providing the first GUI to a user terminal associated with the user.

The first GUI may include a plurality of interactive elements, each of which is associated with an operation for managing the customized design option, wherein the user input may include a user interaction with at least one interactive element of the plurality of interactive elements, and wherein the managing the customized design option may include: determining, based on the user input, the operation associated with the interactive element with which the user has interacted; and performing the operation to manage the customized user input.

The managing the customized design option may further include: based on determining that the operation is a creation of a new customized design option, presenting, to the user, a second GUI including one or more interactive elements for specifying the configuration of the new customized design option; receiving, from the user via the second GUI, a user interaction with the one or more interactive elements; generating, based on the user interaction, a new customized design charter, wherein the new customized design charter may define the user-specified configuration of the new customized design option; and updating, based on the new customized design charter, the first GUI to include information associated with the new customized design option.

The managing the customized design option may further include: based on determining that the operation is a modification of an existing customized design option, presenting, to the user, a second GUI including information associated with the existing customized design option and one or more interactive elements for modifying the existing customized design option; receiving, from the user via the second GUI, a user interaction with the one or more interactive elements; updating, based on the user interaction, a customized design charter associated with the existing customized design option, wherein the updated customized design charter may define a modified customized design option; and updating, based on the updated customized design charter, the first GUI to include information associated with the modified customized design option.

The managing the customized design option may further include: based on determining that the operation is a sharing of an existing customized design option, presenting, to the user, a second GUI including information associated with the existing customized design option and one or more interactive elements for specifying at least one user to which the existing customized design option should be shared; receiving, from the user via the second GUI, a user interaction with the one or more interactive elements; obtaining, based on the user interaction, at least one configuration profile associated with the at least one user; and updating the at least one configuration profile to include an ID of a customized design charter associated with the existing customized design option.

According to embodiments, a non-transitory computer-readable recording medium having recorded thereon instructions executable by at least one processor to cause the at least one processor to perform a method including: presenting, to a user, a first graphical user interface (GUI) including information of a stylistic category; receiving, from the user via the first GUI, a user input for managing a customized design option associated with the stylistic category; and managing the customized design option based on the user input.

The non-transitory computer-readable recording may have recorded thereon instructions executable by the at least one processor to cause the at least one processor to present the first GUI by: obtaining at least one source design charter associated with the stylistic category; generating a listing including at least one design option predefined by the source design charter; generating, based on the listing, the first GUI; and providing the first GUI to a user terminal associated with the user.

The first GUI may include a plurality of interactive elements, each of which is associated with an operation for managing the customized design option, wherein the user input may include a user interaction with at least one interactive element of the plurality of interactive elements, and wherein the non-transitory computer-readable recording may have recorded thereon instructions executable by the at least one processor to cause the at least one processor to manage the customized design option by: determining, based on the user input, the operation associated with the interactive element with which the user has interacted; and performing the operation to manage the customized user input.

The non-transitory computer-readable recording may have recorded thereon instructions executable by the at least one processor to cause the at least one processor to manage the customized design option by: based on determining that the operation is a creation of a new customized design option, presenting, to the user, a second GUI including one or more interactive elements for specifying the configuration of the new customized design option; receiving, from the user via the second GUI, a user interaction with the one or more interactive elements; generating, based on the user interaction, a new customized design charter, wherein the new customized design charter may define the user-specified configuration of the new customized design option; and updating, based on the new customized design charter, the first GUI to include information associated with the new customized design option.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a block diagram of a system for managing stylistic design in an application builder, according to one or more embodiments;

FIG. 2 illustrates a block diagram of a method for managing one or more customized design options, according to one or more embodiments;

FIG. 3 illustrates an example GUI for managing one or more design options associated with a first stylistic category, according to one or more embodiments;

FIG. 4 illustrates an example GUI for adding a new customized design option associated with the first stylistic category, according to one or more embodiments;

FIG. 5 illustrates an example of an updated GUI for managing one or more design options associated with the first stylistic category, according to one or more embodiments;

FIG. 6 illustrates an example GUI for managing one or more design options associated with a second stylistic category, according to one or more embodiments;

FIG. 7 illustrates an example GUI for adding a new customized design option associated with the second stylistic category, according to one or more embodiments;

FIG. 8 illustrates an example of an updated GUI for managing one or more design options associated with the second stylistic category, according to one or more embodiments;

FIG. 9 illustrates an example GUI for utilizing one or more design options, according to one or more embodiments;

FIG. 10 illustrates examples of customized design charters, according to one or more embodiments;

FIG. 11 illustrates an example of a configuration profile, according to one or more embodiments;

FIG. 12 illustrates example mappings of user ID and configuration profile ID, according to one or more embodiments;

FIG. 13 illustrates a block diagram of a method for sharing of a customized design option, according to one or more embodiments;

FIG. 14 illustrates example of updated configuration profiles, according to one or more embodiments;

FIG. 15 illustrates a block diagram of a method for changing a customized design option, according to one or more embodiments;

FIG. 16 illustrates an example use case of changing a customized design option, according to one or more embodiment;

FIG. 17 illustrates another example use case of changing a customized design option, according to one or more embodiments;

FIG. 18 is a diagram of an example environment in which systems and/or methods, described herein, may be implemented; and

FIG. 19 is a diagram of example components of a device, according to one or more embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a system and method for improving the introduction or inclusion of a user's desired stylistic design option in a low-code or no-code application builder (may be referred to as “App builder” hereinafter). Specifically, the example embodiments allow the user to specify intended design requirement via one or more graphical user interfaces (GUIs), and a customized design option will be automatically created based on the user input received via the one or more GUIs.

According to an embodiment, a design charter associated with the customized design option (referred to as “customized charter” hereinafter) may be created or updated, and all user's customization, adjustment, and modification on the customized design options will be made on the associated customized charter, without affecting the design charter utilized by all users (referred to as “source charter” hereinafter). Further, the user may share the customized design option with one or more associated users by allowing said one or more associated users to access or utilize the customized charter, while avoiding disclosing the customized design option to non-associated users.

Furthermore, the system and method of the example embodiments may automatically reflect an update or a change in a design whenever a user has modified or adjusted the associated design option. Specifically, whenever the user would like to adjust or update a design, the user may simply make such adjustment or update via one or more GUIs, and said adjustment or update would be automatically recorded in the associated design charter and will be automatically applied to the associated application(s) or project(s).

Ultimately, example embodiments of the present disclosure simplify the processes of and reduce the user's burden in managing stylistic design in an App builder, provide a user friendly approach to include or adjust a design option via one or more GUIs, improve operational stability by reducing human error, increase efficiency by omitting to-and-fro communication among users, automatically reflect user's update of stylistic design in the associated applications or projects, and improve work efficiency while avoid leakage of sensitive information by allowing sharing of one or more design options among specific users.

### Stylistic Design Management

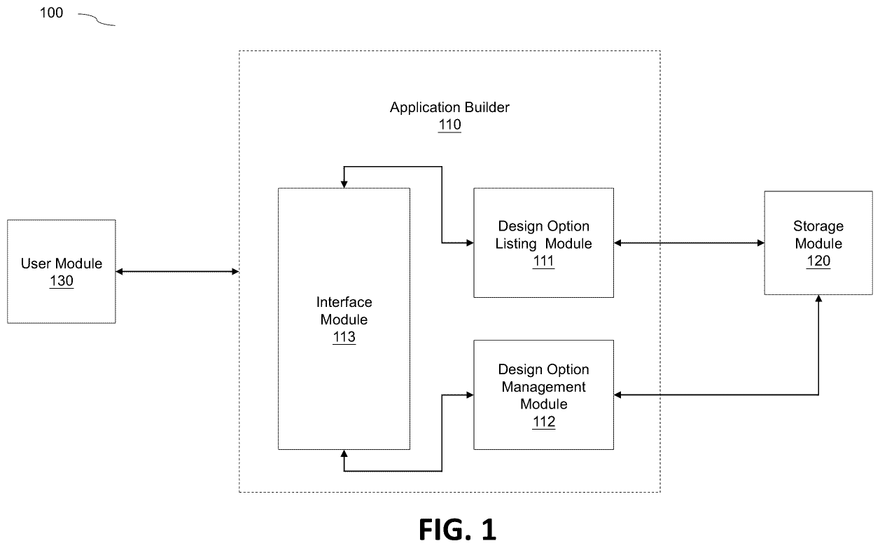

FIG. 1 illustrates a block diagram of a system 100 for managing stylistic design in an application builder, according to one or more embodiments. For instance, system 100 may be utilized for managing one or more design options (e.g., pre-defined design options, customized design options, etc.) associated with one or more categories of stylistic design (may be referred to as “stylistic category” herein), such as color, typography, and the like.

Referring to FIG. 1, system 100 may include an application builder (may be referred to as “App builder” herein) 110, a storage module 120, and a user module 130 (may be respectively referred to as “module 110”, “module 120”, and “module 130” hereinafter).

The user module 130 may include any suitable module, device, or machine which enables a user to access and utilize the App builder 110. For instance, module 130 may include any type of computing, networking, or mobile device, including but not limited to mobile devices and phones such as cellular phones (e.g., any “smart phone”), a personal computer, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including short-range ultra-high frequency (UHF) device, near-field communication (NFC) module, infrared (IR) module, controller area network (CAN) module, universal serial bus (USB) module, high definition multimedia interface (HDMI) module, a Bluetooth™ module, and Wi-Fi module, among others.

The storage module 120 may include any suitable storage medium, such as a server, a web storage, a memory device, and the like, which may store data and information associated with the App builder, such as one or more design charters, one or more configuration profiles, user information, and the like. Further, storage module 120 may be implemented in a plurality of servers (e.g., a server cluster) in one location or in different locations. Furthermore, module 120 may include a plurality of sub-storages, each of which may be configured to store and provide different information. For instance, module 120 may include a first sub-storage for storing a design charter which may be utilized by all users of the App builder (may be referred to as “source charter” herein), and may include a second sub-storage for storing a design charter which is associated with a customized design option (may be referred to as “customized charter” herein) and/or which may be utilized only by one or more specific users.

The application builder 110 may include a design option listing module 111, a design option management module 112, and an interface module 113 (may be respectively referred to as “module 111”, “module 112”, and “module 113” herein).

Interface module 113 may be configured to generate one or more graphical user interfaces (GUIs), to present the generated GUI(s) to the user (e.g., via user module 130) to engage the user, to receive one or more user inputs from the presented GUI(s), and to provide the received one or more user inputs to one or more other modules (e.g., module 111, module 112, etc.) for further processing.

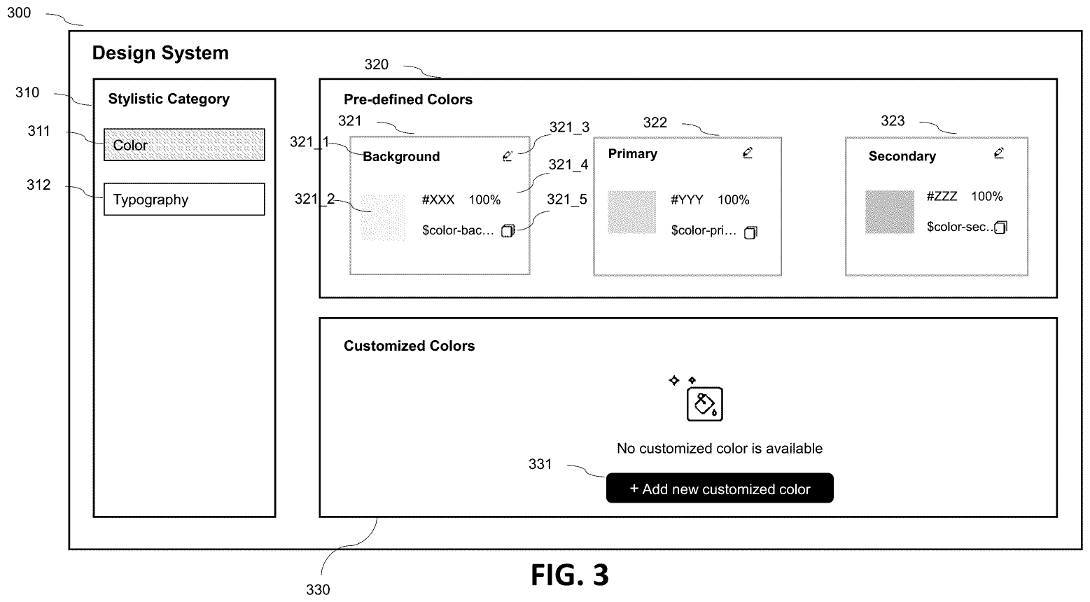

For instance, module 113 may generate and present a login GUI upon detecting an access from a non-login user, so as to allow the user to login to the system by inputting the associated credentials (e.g., user ID, password, etc.) via the login GUI. Further, upon successful login, module 113 may generate one or more GUIs to present one or more available stylistic design options (e.g., available color design options, available typography design options, etc.) such that the user may manage and/or utilize the available stylistic design option(s) via interacting with the one or more GUIs. For instance, module 113 may generate the one or more GUIs to guide the user to, among others, specify, design, modify, create, and utilize a design option. Examples of one or more GUIs generated and provided by module 113 are described below with reference to FIG. 3 to FIG. 9.

Design option listing module 111 may be configured to determine and provide listing of one or more design options available to the user. Specifically, module 111 may be communicatively coupled to the interface module 113 and a storage medium (e.g., storage module 120, etc.), and may be configured to obtain required information from the storage medium, to generate a listing of available design option(s) based on the obtained information and to provide the generated listing to the module 113 for further processing.

For instance, module 111 may be configured to receive user information from module 113 (e.g., information such as user credential received by module 113 during login process, etc.), to continuously (or periodically) obtain (from the storage medium) based on the user information design charter(s) associated with the user, to generate or update the listing of design option(s) available to the user based on the obtained design charter(s), and to provide the listing to the module 113. In this way, the listing of available design option(s) may be updated continuously (or periodically) in real-time or near real-time, and the module 113 may always generate/update and provide one or more GUIs including the updated available design option(s). According to an embodiment, module 111 may be configured to retrieve (from the storage medium) one or more configuration profiles associated with the user based on the user information, and then retrieve the one or more design charters based on the obtained one or more configuration profiles.

Design option management module 112 may be configured to manage one or more design options. Specifically, module 112 may be communicatively coupled to the interface module 113 and a storage medium (e.g., storage module 120, etc.), and to manage (based on user input received and provided by module 113) one or more design charters each of which is associated with a respective design option.

For instance, module 112 may be configured to receive user input from module 113 (e.g., user input received by the module 113 via one or more GUIs provided to the user for managing one or more design options, etc.), and to manage a design charter associated with the user input (e.g., generate a new design charter if the user input is associated with creation or addition of a new customized design option, update an existing design charter if the user input is associated with modification of an existing design option, delete an existing design charter if the user input is associated with deletion or disabling of an existing design option, share an existing design charter if the user input is associated with sharing of an existing design option, etc.).

In this regard, module 113 may be configured to manage (e.g., generate, update, remove, etc.) one or more design charters pre-defined by another user (e.g., provider of the App builder, system admin, etc.), design charter shared by said another user, etc., (may be referred to as “source charter” herein), one or more design charters associated with one or more design options customized by the user (may be referred to as “customized charter” herein), and the associated information (e.g., configuration profile(s), information of associated user(s), etc.). Subsequently, the module 112 may be configured to store, retrieve, and/or remove the one or more design charters and the associated information from the storage medium.

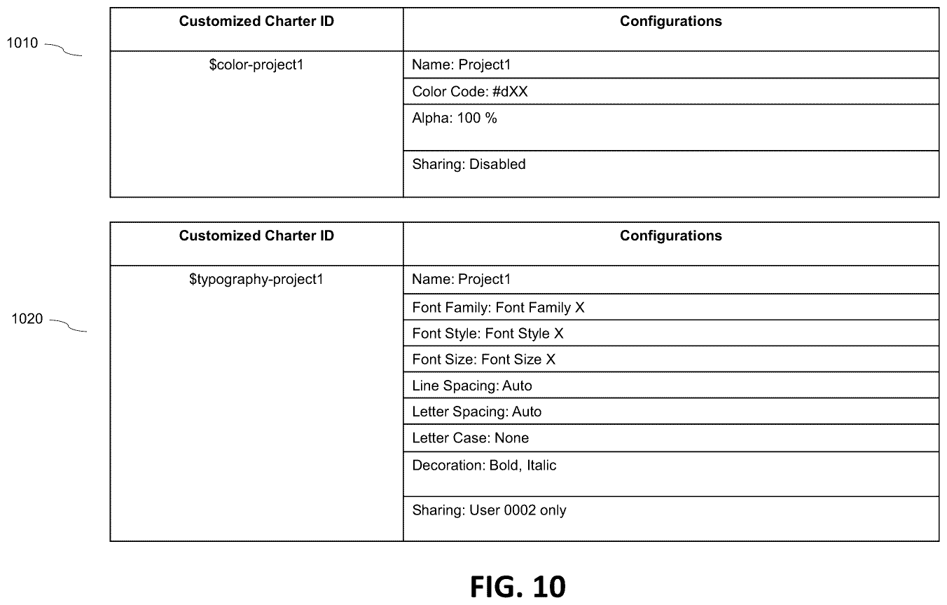

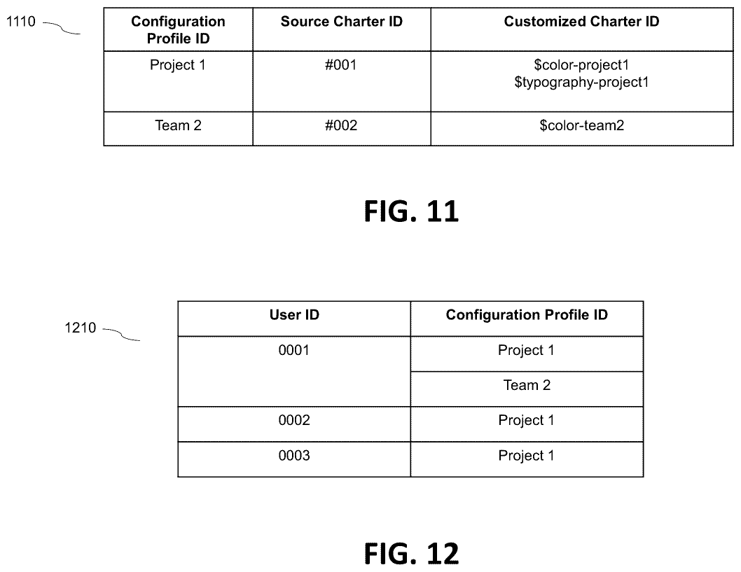

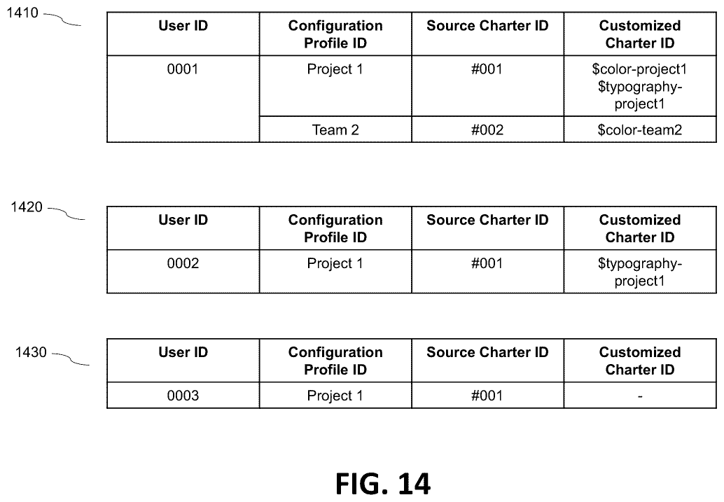

By way of an example, module 112 may receive (from module 113) one or more user inputs defining an action to manage a customized design option (e.g., creating a new customized design option, updating an existing customized design option, sharing an existing customized design option, etc.), and generate a new customized design option (if the action is to create or add a new customized design option) or update the associated customized design charter (if the action is associated with an existing customized design option), based on the received user input(s). Accordingly, module 112 may generate or update information associated with the design option, such as information in a customized charter (e.g., customized charter ID, configuration of customized design option, etc.), information in a configuration profile (e.g., mapping of configuration profile ID and customized charter ID, etc.), and the like. Examples of customized design charter are described below with reference to FIG. 10, and examples of configuration profiles are described below with reference to FIG. 11, FIG. 12, and FIG. 14.

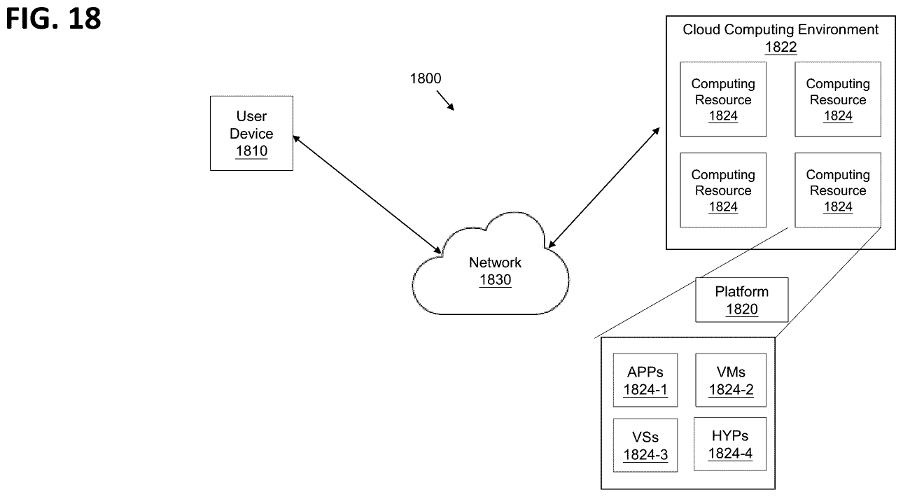

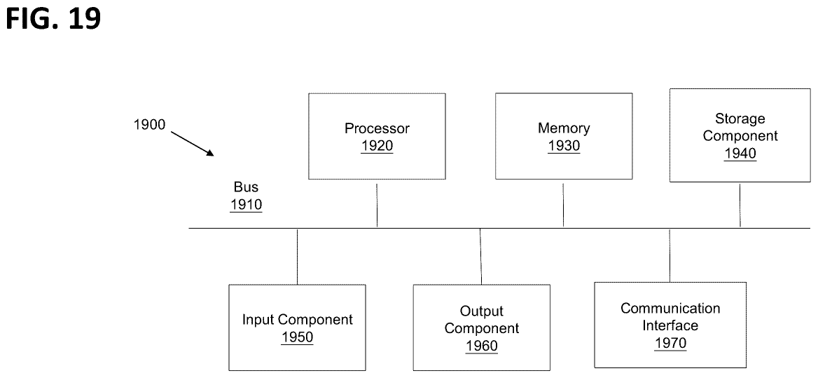

To this end, module 111, module 112, module 113, and a combination thereof, may enable the user to easily manage and utilize one or more design options. One or more of module 110, module 120, and module 130 may be implemented in an environment described below with reference to FIG. 18, and may include one or more components described below with reference to FIG. 19.

Furthermore, it is contemplated that the configuration of system 100 may be arranged in a manner different from those described above, without departing from the scope of the present disclosure. For instance, system 100 may include more than one user module 130, App builder 110 may include additional modules, and the like. In addition, one or more of module 111, module 112, and module 113 may be combined to each other and function as one module. For example, module 111 and/or module 112 may be configured to perform one or more operations of module 113, module 111 and module 112 may be configured to perform one or more operations of one another, and the like. Further, one or more of modules 111-113 may be deployed in the form of computer-readable or computer-executable instructions which, when being executed by at least one processor, cause the at least processor to perform one or more operations of said modules 111-113.

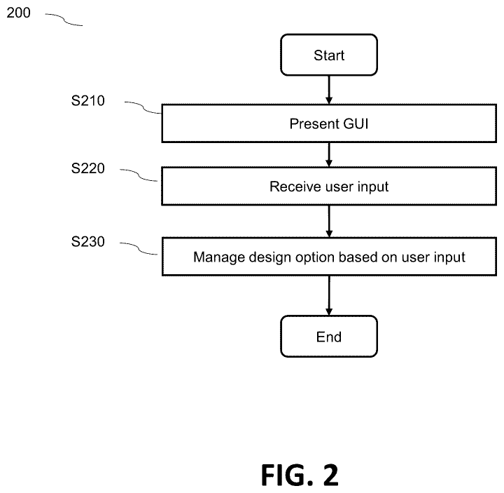

FIG. 2 illustrates an example block diagram of a method 200 for managing one or more design options, according to one or more embodiments. Method 200 may be performed by App builder 110 (or one or more modules included therein) whenever a user would like to manage one or more design options (e.g., add or create a new customized design option, modify or update an existing customized design option, etc.), after the user has successfully login to the system.

Referring to FIG. 2, at operation S210, one or more GUIs are presented to the user. For instance, a first GUI including information of one or more design option(s) associated with a stylistic category (e.g., color, typography, etc.) may be presented to the user.

Specifically, the design option listing module 111 of the App builder 110 may be configured to: receive, from the interface module 113, user information (e.g., obtained by the module 113 during login process, etc.); obtain, from one or more storage mediums (e.g., storage module 120), one or more design charters associated with the user; generate (based on the received one or more design charters) a listing defining one or more design options associated with a stylistic category; and provide the generated listing to module 113. Accordingly, module 113 may generate and provide the first GUI to user module 130, such that user module 130 may present said first GUI to the user.

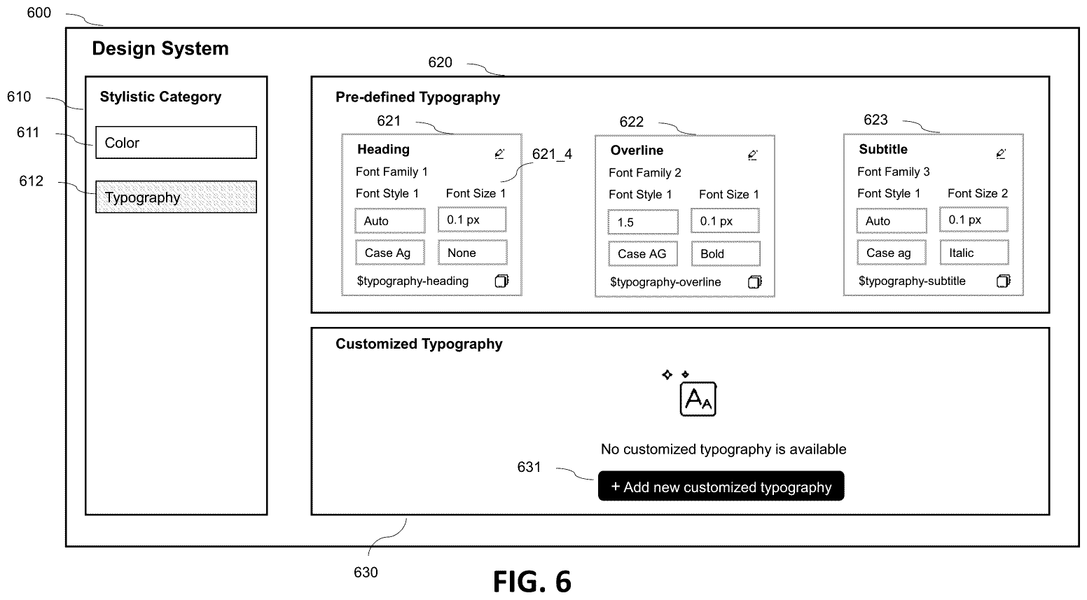

Assuming that there is no customized design option available to the user (i.e., there is no customized charter associated with the user), module 111 may retrieve only source charter(s) associated with the user from the storage medium, and may generate a listing containing one or more design options predefined by the source charter(s). Said pre-defined design options may be defined by, for example, the developer or admin of App builder 110, and may include one or more general design options (e.g., frequently utilized design options, etc.) applicable to all users of App builder 110. In this case, the first GUI presented to the user may include only the pre-defined design options. For examples, referring to FIG. 3 and FIG. 6, which exemplify GUIs that contain only pre-defined design options (e.g., options of pre-defined color, options of pre-defined typography). In this regard, FIG. 3 illustrates an example GUI for managing one or more design options associated with a first stylistic category (e.g., color) according to one or more embodiments, while FIG. 6 illustrates an example GUI for managing one or more design options associated with a second stylistic category (e.g., typography) according to one or more embodiments. Further descriptions of the features in the GUI of FIG. 3 and in the GUI of FIG. 6 will be further provided below.

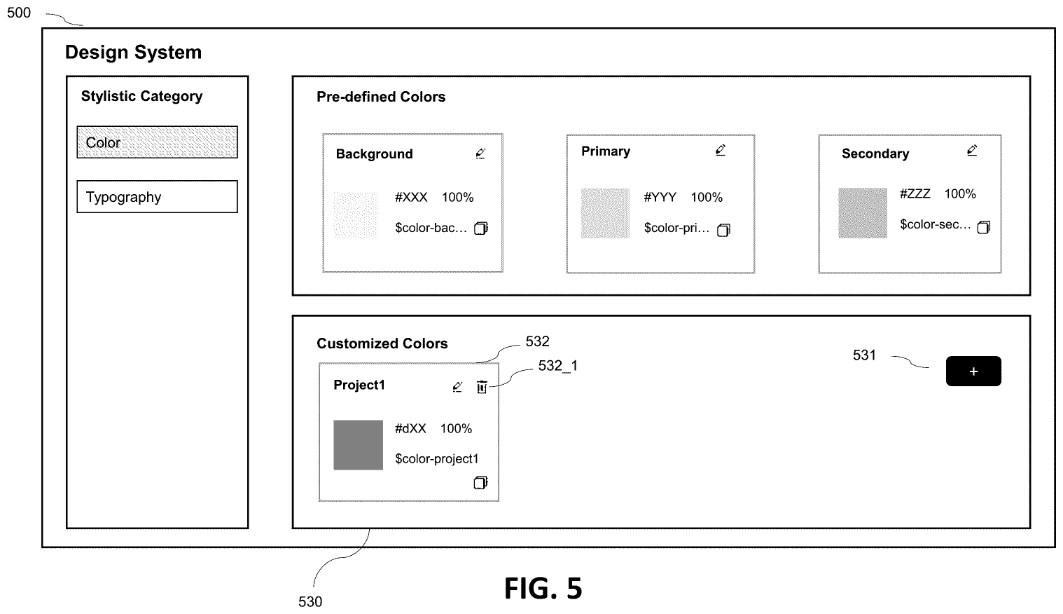

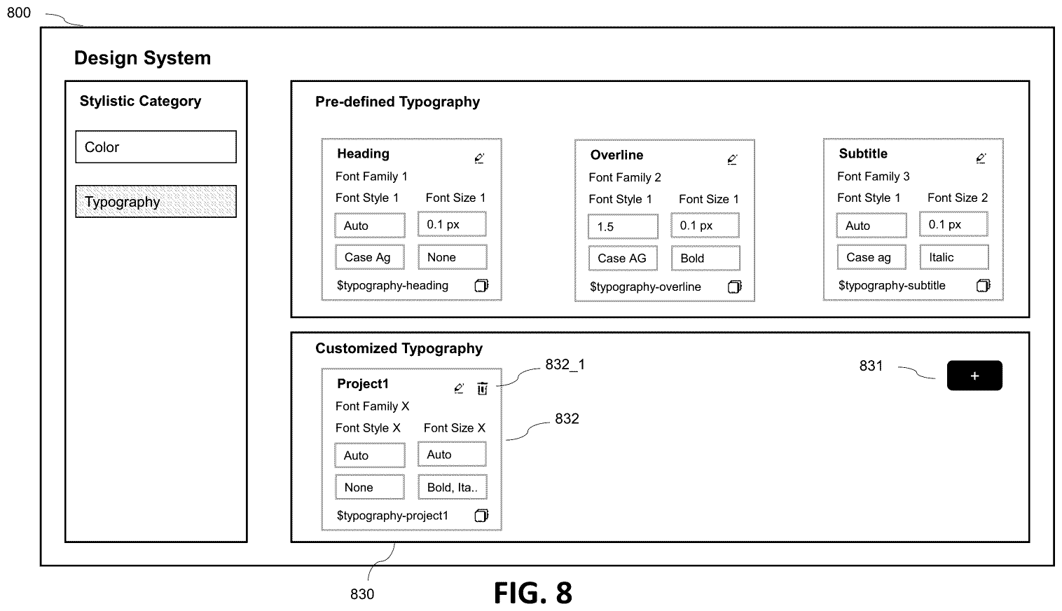

In other embodiments which there is one or more customized design options available to the user, module 111 may retrieve both source charter(s) and customized charter(s), and may generate a listing including design option(s) defined by the source charter(s) and design option(s) defined by the customized charter(s). Accordingly, module 111 may provide the listing to module 113, and module 113 may generate the first GUI which include information of design options associated with both source charter(s) and customized charter(s). For examples, referring to FIG. 5 and FIG. 8, which exemplify GUIs that contain pre-defined design options (e.g., design options of pre-defined colors, design options of pre-defined typography) and a customized design option (e.g., design option of a customized color, design option of a customized typography, etc.). In this regard, FIG. 5 may be an updated version of GUI of FIG. 3, while FIG. 8 may be an updated version of GUI of FIG. 6. Further descriptions of the features in the GUI of FIG. 5 and in the GUI of FIG. 8 will be further provided below.

Referring back to FIG. 2, at operation S220, one or more user inputs are received. Specifically, module 113 may receive one or more user interactions on one or more interactive elements of the presented GUI, wherein each the one or more interactive elements is associated with an operation for managing one or more design options. For instance, the user input may be a user interaction with an interactive element (e.g., a button, an icon, etc.) for creating or adding a new customized design option, a user interaction with an interactive element (e.g., a button, an icon, etc.) for modifying an existing customized design option, a user interaction with an interactive element (e.g., a button, an icon, etc.) for deleting or removing an existing customized design option, a user interaction with an interactive element (e.g., a button, an icon, etc.) for sharing an existing customized design option, and the like.

Subsequently, at operation S230, the customized design option associated with the user input may be managed based on the operation associated with the user input. According to an embodiment, upon receiving the user input, the module 113 may provide the user input to the module 112. Subsequently, module 112 may be configured to determine, based on the user input, an operation associated with the interactive element with which the user has interacted, and to perform the operation to manage (e.g., add, modify, share, delete, etc.) the customized design option accordingly.

In an example embodiment in which there is no customized design option available to the user and the user input is a user interaction (e.g., clicking, etc.) with the interactive element creating or adding a new customized design option, one or more additional GUIs may be generated and presented to the user, so as to receive additional user input(s) for creating or adding the new customized design option. In this example embodiment, the module 112 may determine that an operation for adding or creating a new customized design option is triggered, based on determining that the user has interacted with the interactive element for creating or adding a new customized design option. Subsequently, module 112 may notify module 113 such that module 113 may be configured to generate and present a second GUI for allowing the user to specify the configuration of the new customized design option therefrom. Alternatively, instead of simply forwarding the user input to module 112, module 113 may be configured to determine the operation associated with the interactive element with which the user has interacted, and may generate and present the second GUI accordingly, without departing from the scope of the present disclosure.

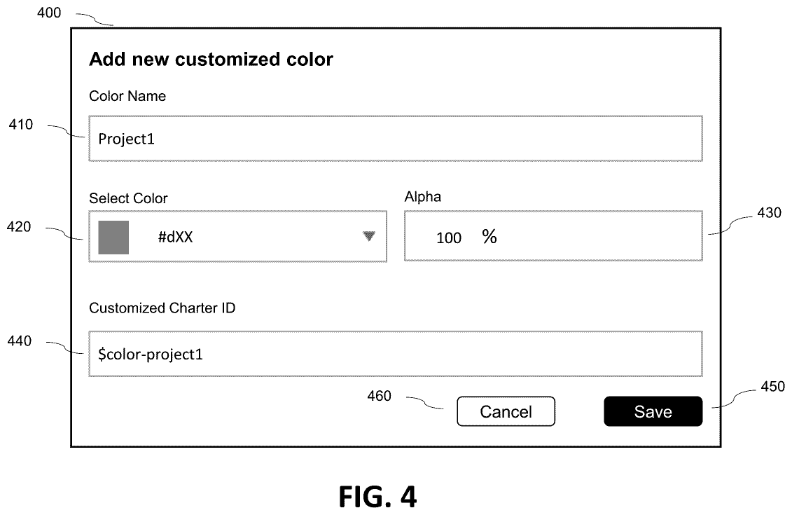

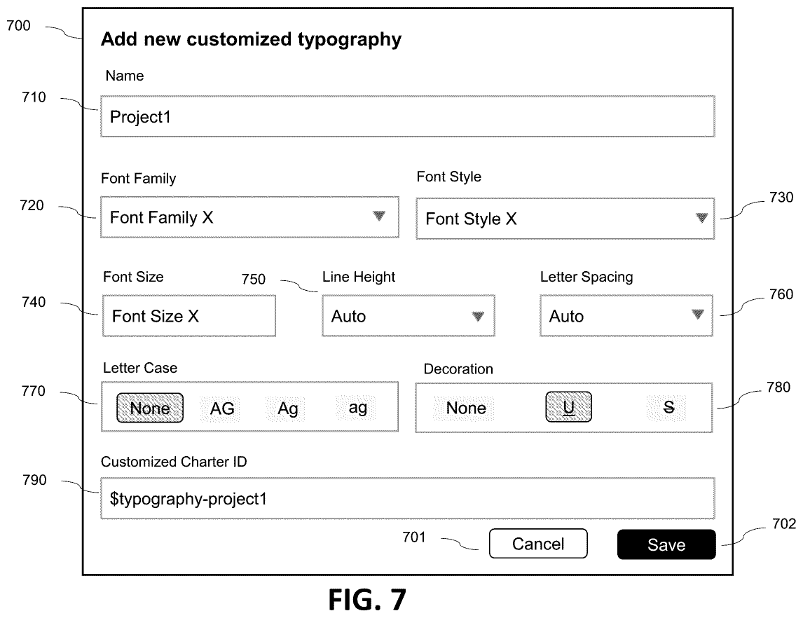

The second GUI may include a plurality of interactive elements (e.g., input fields, buttons, etc.) each of which is associated with a parameter for specifying the customized design option or is associated with a respective operation (e.g., creating a customized design option, saving the current configuration, cancelling the creation of new customized design option, etc.). Further, the second GUI may be presented in the form of a sub-window overlaying the first GUI (described above in relation to operation S210). Referring to FIG. 4 and FIG. 7, which exemplify GUIs for adding a new customized design option. In this regard, FIG. 4 illustrates an example GUI for adding a new customized design option associated with the first stylistic category (e.g., adding new customized color) according to one or more embodiments, while FIG. 7 illustrates an example GUI for adding a new customized design associated with the second stylistic category (e.g., adding new customized typography) according to one or more embodiments. Further descriptions of the features in the GUI of FIG. 4 and in the GUI of FIG. 7 will be further provided below.

In other embodiments which customized design option(s) is available, the user input may include one or more user interactions with one or more interactive elements (e.g., a button, an icon, etc.) for modifying the existing customized design option(s), for sharing the existing customized design option(s), for removing the existing customized design option(s), and the like. In that case, the module 113 may be configured to generate and to provide the second GUI, which include information associated with the existing customized design option(s) and one or more interactive elements for modifying the existing customized design option(s).

According to embodiments, the second GUI may be similar to the GUI illustrated in FIG. 4 and FIG. 7, with one or more parameters in the second GUI pre-populated or pre-filled by the system. For instance, based on determining that the user has interacted with an interactive element associated with an operation for modifying an existing customized design option, the module 113 may obtain from module 111 information associated with the existing customized design option (e.g., information included in design charter associated with the existing customized design option which is retrieved by module 111 when generating the listing of design option at operation S210, etc.), and generate the second GUI based on the obtained information, wherein the second GUI may include one or more interactive elements pre-populated or pre-filled with one or more parameters defining the configuration of the existing customized design option, such that the user may simply modify or adjust the configuration of the existing customized design option by interacting with the respective interactive element.

Accordingly, module 113 may be configured to receive one or more additional user inputs via the second GUI. For instance, module 113 may receive one or more user interactions with the one or more interactive elements included in the second GUI. Subsequently, module 113 may provide the received additional user input(s) to module 112, and module 112 may be configured to manage the associated customized design option based on the received additional user input(s).

In an embodiment in which the operation for managing the customized design option is an operation of creating or adding a new customized design option, the module 112 may be configured to generate, based on the additional user input(s) received via the second GUI, a new customized design charter (may be referred to as “customized charter” herein) defining the user-specified configuration of the new customized design option. Further, the module 112 may be configured to update one or more configuration profiles associated with the user to update said one or more configuration profiles with the information of the new customized charter (e.g., ID of the new customized charter, etc.).

In another embodiment in which the operation for managing the customized design option is an operation for modification of an existing customized design option, the module 112 may be configured to update, based on the additional user input(s) received via the second GUI, a customized charter associated with the existing customized design option so as to include the user-modified configuration on the customized design option.

In yet another embodiment in which the operation for managing the customized design option is an operation for sharing an existing customized design option, the module 112 may be configured to obtain one or more configuration profiles each of which associated with one or more users to which the existing customized design option should be shared (e.g., one or more users selected or specified by the user via the second GUI, etc.), and to update the one or more configuration profiles to include the information of the customized charter associated with the to-be shared customized design option.

In yet another embodiment, in which the operation for managing the customized design option is an operation for deleting or removing an existing customized design option, the module 112 may be configured to disable or remove the customized charter associated with the customized design option, and may be configured to update the configuration profile(s) which has included the information of the customized charter (e.g., remove the ID of the customized charter, etc.).

Upon completing the operation, module 113 may be configured to generate and present an updated GUI to the user. For instance, module 113 may be configured to update the first GUI (which includes the information of available design options associated with a stylistic category) based on the latest information.

For instance, upon completion of creation of a new customized design option, the associated customized charter may be stored by module 112 in the storage medium. Accordingly, module 111 may retrieve the design charters associated with the user (i.e., one or more source charters and the newly stored customized charter) from the storage medium, generate an updated listing of available design options including the pre-defined design options (defined by the source charter) and the customized design option (defined by the new customized charter), and provide the updated listing to module 113. Subsequently, module 113 may generate an updated GUI including the updated available design options and present the same to the user (e.g., via user module 130). Similar operations or processes are applicable to other embodiments, such as embodiment associated with operation for modifying an existing customized design option, embodiment associated with operation for sharing an existing customized design option, and embodiment associated with operation for removing an existing customized design option, in a similar manner.

In view of the above, example embodiments of the present disclosure allow a user to easily manage one or more design options. Specifically, the process of managing the design options (e.g., adding, modifying, removing, etc.) can be performed directly by the user via one or more GUIs to fulfill a specific design requirement, without involvement of other users (e.g., provider of source charter, admin of App builder, etc.). Accordingly, to-and-fro communication among multiple users may be avoided, and the efficiency and effectiveness of managing the design option(s) may be improved. Further, since the process of managing the design option(s) is performed via one or more GUIs, inexperience user may easily manage the design option(s) and the risk of introducing errors during the management of design option(s) may be reduced.

### Graphical User Interfaces (GUIs) of Example Embodiments

As discussed above, the App builder (or one or more modules included therein) may generate and present one or more graphical user interfaces (GUIs) which allow a user to manage the stylistic design option(s) therefrom. Further descriptions of the associated GUIs will be provided hereinbelow.

Referring first to FIG. 3 to FIG. 5, which illustrate example GUIs presented to a user for managing one or more design options associated with a first stylistic category (e.g., color), according to one or more embodiments. Specifically, FIG. 3 illustrates an example GUI 300 for managing available design options associated with the first stylistic category, when there is no customized design option of the first stylistic category available to the user; FIG. 4 illustrates an example GUI 400 for adding a new customized design option associated with the first stylistic category; and FIG. 5 illustrates an example GUI 500 which may be an updated version of GUI 300 including the customized design option added via GUI 400.

As illustrated in FIG. 3, GUI 300 may include a first partition 310, a second partition 320, and a third partition 330.

The first partition 310 may include a listing of available stylistic categories, wherein each of the available stylistic categories are presented in an associated interactive block element. In the example illustrated in FIG. 3, two stylistic categories, i.e., color and typography, are available to the user, and thus first partition 310 includes a first block element 311 associated with the first available stylistic category (i.e., color) and a second block element 312 associated with the second available stylistic category (i.e., typography). The user may opt to manage design option(s) associated with any of the two stylistic categories by interacting (e.g., clicking with a mouse, pressing a key on a keyboard, etc.) with the respective block element.

According to an embodiment, the block element associated with the stylistic category selected by the user may be presented in a distinguishing manner (e.g., highlighted, filled with a pattern, etc.) from other block elements. For instance, in the example illustrated in FIG. 3, the user has selected to manage design option(s) associated with “color”, thus the associated block element 311 filled with diagonal lines. Subsequently, based on the selected stylistic category, the App builder (or one or more modules included therein) may update the second partition 320 and the third partition 330 of GUI 300 to present the available design option(s) associated with the selected stylistic category.

The second partition 320 may include information of one or more available pre-defined design options associated with the stylistic category selected by the user in the first partition 310. The one or more available pre-defined design options may be defined by one or more source charters associated with the user. According to an embodiment, the information of each of the available pre-defined design options may be presented in a respective interactive block element. For instance, in the example embodiment illustrated in FIG. 3, three pre-defined design options are available to the user, and the information of each of the three available pre-defined design options are included in an interactive block element 321, an interactive block element 322, and an interactive block element 323, respectively, in the second partition 320.

As illustrated in FIG. 3, block element 321 may include information such as (but are not limited to): a title or name 321_1, a preview icon 321_2, an edit icon 321_3, a summary of configuration 321_4, and a copy icon 321_5. Block element 322 and block element 323 may include the similar components.

The preview icon 321_2 may illustrate the color mapped to or assigned to the respective design option. The edit icon 321_3 may be an interactive element which, when being interacted by a user, allow the user to edit one or more configurations of the design option. For instance, upon detecting a user interaction with the edit icon 321_3, the App builder (or one or more modules included therein) may generate and present one or more additional GUIs to allow the user to edit the one or more configurations of the design option therefrom. The summary of configuration 321_4 may include part of or all of current configurations (e.g., color code, alpha setting, customized charter ID, sharing settings, etc.) of the design option. In this regard, it can be understood that the terms “$color-bac . . . ”, “$color-pri . . . ”, “$color-sec . . . ” illustrated in FIG. 3 are the short form of “$color-background”, “$color-primary”, and “$color-secondary”, respectively, which are according to the format of “$color-name of design option”.

The copy icon 321_5 may be an interactive element which, when being interacted by a user, allow the user to copy one or more configurations of the design option. For instance, upon detecting a user interaction with the copy icon 321_5, the App builder (or one or more modules included therein) may generate and present one or more additional GUIs to allow the user to copy the one or more configurations of the design option therefrom. According to another embodiment, upon detecting the user interaction with the copy icon 321_5, the App builder (or one or more modules included therein) may automatically generate a new design charter and an associated configuration profile, and may update the GUI 300 to include the copied design option. For instance, the App builder may automatically generate a new customized charter and the associated configuration profile, and may update the third partition 330 to present the copied design option as a new customized design option.

Referring still to FIG. 3, the third partition 330 may include information of one or more available customized design options associated with the stylistic category selected by the user in the first partition 310, and may include an interactive element 331 to allow the user to add a new customized design option.

In the example embodiment illustrated in FIG. 3, since there is no available customized design option of the selected stylistic category, the third partition 330 may include a statement (e.g., “No customized color is available”, etc.) notifying the user regarding the same, and the interactive element 331 may include a label or statement (e.g., “Add new customized order”) such that the user may easily understand that he/she may add a new customized design option by interacting with interactive element 331. Upon detecting a user interaction with the interactive element 331, the App builder0. (or one or more modules included therein) generate and present one or more additional GUIs to allow the user to add a new customized design option by specifying one or more configurations of the desired design option therefrom.

FIG. 4 illustrates an example GUI 400 for adding a new customized design option, according to one or more embodiments. The GUI 400 may be generated and presented to the user, upon detecting a user interaction with the interactive element 331 of GUI 300 in FIG. 3, and may be presented in the form of a sub-window overlaying the GUI 300. Further, GUI 400 may include multiple interactive elements, each of which may be interacted by the user to define an associated configuration of the customized design option. For instance, as illustrated in FIG. 4, GUI 400 may include a plurality of interactive input fields 410, 420, 430, and 440, and a plurality of interactive buttons 450 and 460.

The user may interact with the input field 410 to specify or define the name of the customized design option (i.e., the name of the customized color). In the example embodiment illustrated in FIG. 4, the user has inputted or specified “Project1” as the name of the customized design option. According to an embodiment, the parameter in the input field 410 (i.e., the name of the customized design option) may be prepopulated by the App builder (or one or more modules included therein). For instance, when the user triggers GUI 400 for adding new customized color by copying an existing design option (e.g., by interacting with interactive element 321_5 in FIG. 3, etc.), the App builder (or one or more modules included therein) may determine the name/title of the copied existing design option and prepopulate the parameter of the input field 410 according to the name of the existing design option. Alternatively, the App builder (or one or more modules included therein) may determine (e.g., from a user profile, etc.) a project or an application the user is working on, and may prepopulate the parameter of the input field 410 according to the ID or title of the project or application.

Further, the user may interact with input field 420 to specify or select the desired color. As illustrated in FIG. 4, input field 420 may be a drop-down list which, when being interacted (e.g., clicked, etc.) by the user, present a list of selectable options (e.g., options of color, etc.) which allow the user to specify or select the desired color therefrom.

In another embodiment, upon determining a user interaction with input field 420, one or more additional GUIs may be generated and presented to the user so as to enable the user to select and configure a desired color therefrom. For instance, the one or more additional GUIs may be presented in the form of one or more sub-windows overlaying GUI 400, and may include a color gradient, a color ramp, and the like, which allow the user to directly select a desire color by clicking on the desired color zone. Further, the one or more additional GUIs may also include one or more sliders which the user may adjust (e.g., by sliding one or more interactive icon of the slider, by inserting a value, etc.) the configuration of the color according to color channels, such as (but are not limited to): red, green, and blue (RGB) channels; cyan, magenta, yellow, and key (CMYK) channels; and hue, saturation and brightness (HSB) channels.

Subsequently, upon determining a user selection or specification on the desired design option (e.g., desired color, desired color saturation, etc.), the App builder (or one or more modules included therein) may determine or generate a color code associated with a color defined by the user selection or specification, and may update input field 420 to reflect or present the color and the color code therein.

Referring still to FIG. 4, input field 430 may be interactable by the user to specify or configure the alpha (e.g., the strength or intensity level of the color) of the customized design option (i.e., the color selected or specified by the user in input field 420). In the example embodiment illustrated in FIG. 4, input field 430 is a text field in which the user may input the desired alpha configuration (between the range of 0% to 100%) into the input field. According to another embodiment, the input field 430 may be a drop-down list which, when being interacted by the user, present a list of options for one or more alpha ranges, such that the user may simply select an alpha configuration from the drop-down list.

Further, input field 440 may be interactable by the user to specify or configure an ID for the customized charter associated with the customized design option (may be referred to as “customized charter ID” herein). For instance, input field 440 may be partially prepopulated (by the App builder or one or more modules included therein) with a portion of the ID and the user may insert an appropriate label to specify the customized charter ID. By way of example, the input field 440 may be prepopulated with the labeling “$color-” and the user may further specify the ID by inserting “project1” in the input field 440.

According to another embodiment, the customized charter ID in input field 440 may be automatically populated (by the App builder or one or more modules included therein) based on the parameter inputted or specified by the user in input field 410. For instance, in the example embodiment illustrated in FIG. 4, the user may input “Project1” as the parameter for defining the name of the customized design option in input field 410, and the App builder (or one or more modules included therein) may automatically generate a customized charter ID of “$color-project1” and may update the input field 440 to present the auto-generated customized charter ID to the user. In this regard, the user may simply accept the auto-generated customized charter ID, or may opt to modify said auto-generated customized charter ID (e.g., by altering the parameter in input field 440, etc.). In some embodiments, the parameter in the input field 440 (i.e., the customized charter ID auto-generated by the App builder and/or specified by the user) may be processed or be converted (e.g., by the App builder or one or more modules included therein) into a hypertext (or any other suitable format) which may interconnect the customized charter of the customized design option with an interactive element and the associated configuration profile. In this way, whenever the user changes or modifies one or more of the configurations (e.g., changes the color name, etc.), said changes will be automatically reflected in the customized charter ID as well as in the associated customized charter ID and configuration profile.

Referring still to FIG. 4, upon configuring or specifying one or more configurations of the customized design option via the respective input field, the user may interact (e.g., clicking, etc.) with interactive element 450 (illustrated as a “Save” button in FIG. 4), and the App builder (or one or more modules included therein) may retrieve and collect said one or more configurations and generate a new customized charter based thereon. Subsequently, the App builder (or one or more modules included therein) may update one or more configuration profiles associated with the user to include the customized charter ID thereto, and may update one or more GUIs presented to the user (e.g., GUI 300) to include the information of the newly added customized design option. Further descriptions associated with the updated GUI are provided below with reference to FIG. 5.

On the other hand, interactive element 460 may be interactable by the user to stop or discard the addition of new customized design option. According to an embodiment, upon determining a user interaction with the interactive element 460 (e.g., user pressing the “cancel” button, etc.), the App builder (or one or more modules included therein) may query the user for saving the current configuration for future user (e.g., save the partially configured design option in a record file and store the record file in storage module 120, etc.). Alternatively, the App builder (or one or more modules included therein) may simply close GUI 400 and redirect the user back to the previous GUI (e.g., GUI 300 in FIG. 3, etc.).

It can be understood that, although FIG. 4 and the associated features are described in relation to function or process for adding a new customized design option, similar GUI and process may be presented to the user to adjust or modify the configuration of design options of the first stylistic category available to the user, without departing from the scope of the present disclosure. For instance, a GUI containing similar input fields and interactive elements may be presented to the user upon a user interaction with an associated interactive element (e.g., edit icon 321_3), wherein the input fields of the GUI may be pre-populated with one or more of the current configurations of the design option.

FIG. 5 illustrates an example of updated GUI 500 for managing one or more design options associated with the first stylistic category, according to one or more embodiments. GUI 500 may be presented by the App builder (or one or more modules included therein) upon determining a user interaction on the interactive element 450 in FIG. 4. Further, GUI 500 may be an updated version of GUI 300 in FIG. 3 and may include one or more features, information, and interactive elements of GUI 300, thus the redundant descriptions associated therewith may be omitted below for conciseness.

Referring to FIG. 5, the third partition 530 of GUI 500 may include an interactive block element 532 associated with the customized design option available to the user (e.g., customized color added by the user via GUI 400 in FIG. 4, etc.). As illustrated in FIG. 5, in addition to the information and interactive elements described above in relation to block element 321 (e.g., title/name, preview icon, edit icon, summary of configuration, copy icon, etc.), block element 532 may include an additional interactive element 532_1 which, when being interacted by the user, remove or delete the associated customized design option. In the example embodiment illustrated in FIG. 5, interactive element 532_1 is presented in the form of a bin icon, although it can be understood that said interactive element 532_1 may also be presented in any other suitable manner without departing from the scope of the present disclosure. According to an embodiment, upon determining a user interaction with interactive element 532_1, the App builder (or one or more modules included therein) may remove the associated customized charter, update the associated configuration profile(s) and update the GUI 500 accordingly.

Referring still to FIG. 5, the third partition 530 of GUI 500 may include an interactive element 531 which, when being interacted by a user, generate and present one or more additional GUIs to allow the user to configure one or more configurations of the desired design option therefrom. The function of interactive element 531 may be similar to interactive element 331 in FIG. 3, while the graphical representation of interactive element 531 may be different from interactive element 331 in that interactive element 531 may be presented in a simpler way (e.g., may be presented with a “+” icon indicating that the interactive element 531 is associated with function for adding new customized design option), considering that the user has already added a customized design option and may be familiar with the process at this stage. According to another embodiment, interactive element 531 may be similar to interactive element 331 in terms of functionality and graphical representation.

To this end, the user may manage one or more design options associated with the first stylistic category (e.g., color) via the above described GUI 300 to GUI 500. For instance, the user may add one or more new customized colors, may edit or configure one or more available color design options presented in the GUIs (e.g., edit the name of the pre-defined color design options, change a color code of a customized design options, etc.), may share one or more available color design options, may remove one or more available customized color design options, and the like.

Next, referring to FIG. 6 to FIG. 8, which illustrate example GUIs presented to a user for managing one or more design options associated with a second stylistic category (e.g., typography), according to one or more embodiments. Specifically, FIG. 6 illustrates an example GUI 600 for managing available design options associated with the second stylistic category, in which there is no customized design option of the second stylistic category available to the user; FIG. 7 illustrates an example GUI 700 for adding a new customized design option associated with the second stylistic category; and FIG. 8 illustrates an example GUI 800 which may be an updated version of GUI 600 including the customized design option added via GUI 700.

GUI 600 to GUI 800 may include one or more features or information similar to those included in GUI 300 to GUI 500 described above with reference to FIG. 3 to FIG. 5, respectively. Thus, redundant descriptions associated therewith may be omitted in below for conciseness.

For instance, similar to GUI 300, GUI 600 may also include a first partition 610, a second partition 620, and a third partition 630, each of which may include information and features similar to the first partition 310, the second partition 320, and the third partition 330 in GUI 300, respectively.

Specifically, the first partition 610 may include a first interactive block element 611 and a second interactive block element 612, which may corresponds to the first interactive block element 311 and the second interactive block element 312, respectively, in the first partition 310 of GUI 300. In the example embodiment illustrated in FIG. 6, since the user has selected to manage design option(s) associated with “typography”, the second block element 612 associated therewith may be presented in a distinguishing manner (e.g., filled with diagonal lines) from the first block elements 611. Subsequently, based on the selected stylistic category, the App builder (or one or more modules included therein) may update the second partition 620 and the third partition 630 of GUI 600 to present the associated design options. In this regard, the user may interact with the first block element 611, and the App builder (or one or more modules included therein) may redirect the user to the GUI (e.g., GUI 300, GUI 500, etc.) associated with the first stylistic category to allow the user to manage design option(s) associated with the first stylistic category.

Further, similar to the second partition 320 of GUI 300, the second partition 620 of GUI 600 may include information of one or more available pre-defined design options associated with the stylistic category selected by the user in the first partition 610. Further, similar to the second partition 320, the information of each of the available pre-defined design options may be presented in a respective interactive block element. In the example embodiment illustrated in FIG. 6, three pre-defined design options associated with the second stylistic category are available to the user, and the information of each of the three available pre-defined design options are included in an interactive block element 621, an interactive block element 622, and an interactive block element 623, respectively, in the second partition 620.

In this regard, each of the block element 621, the block element 622, and the block element 623 of the second partition 620 of GUI 600 may include one or more information and/or one or more interactive elements similar to those included in block elements of the second partition 320 of GUI 300, such as: a title or name, an edit icon, a summary of configuration, and a copy icon, thus the redundant descriptions associated therewith may be omitted in below for conciseness.

Further, each of the block element 621, the block element 622, and the block element 623 of the second partition 620 of GUI 600 may include one or more information and/or one or more interactive elements different from those included in block elements of the second partition 320 of GUI 300. As illustrated in FIG. 6, the block elements of the second partition 620 may not include a preview icon similar to the preview icon 321_2 in the block elements of the second partition 320 (although it can be understood that a preview icon may be included if required, without departing from the scope of the present disclosure), and the summary of configuration 621_4 in the second partition 620 may contain more information as compared to the summary of configuration 321_4 in the second partition 320. To this end, it can be understood that the block elements of the second partition may include information and interactive element(s) which may vary according to the stylistic category, so as to provide to the user appropriate and comprehensive information of the design option(s) associated to the stylistic category, as well as to simplify the management of said design option(s) by providing the user appropriate guidance therefrom.

Referring still to FIG. 6, similar to the third partition 330 of GUI 300, the third partition 630 of GUI 600 may include information of one or more available customized design options associated with the stylistic category selected by the user in the first partition 610, and may include an interactive element 631 to allow the user to add a new customized design option.

In the example embodiment illustrated in FIG. 6, since there is no available customized design option of the second stylistic category, the third partition 630 may include a statement (e.g., “No customized typography is available”, etc.) notifying the user regarding the same, and the interactive element 631 may include a label or statement (e.g., “Add new customized typography”, etc.) such that the user may easily understand that he/she may add a new customized design option of the selected stylistic category by interacting with interactive element 631. Upon detecting a user interaction with the interactive element 631, the App builder (or one or more modules included therein) generate and present one or more additional GUIs to allow the user to configure one or more configurations of the desired design option therefrom.

Referring to FIG. 7, which illustrates a GUI 700 for adding a new customized design option associated with the second stylistic category. As illustrated in FIG. 7, GUI 700 may include one or more information and/or one or more interactive elements similar to those included in the GUI 400 (i.e., GUI for adding a new customized deign option associated with the first stylistic category) described above with reference to FIG. 4. For instance, GUI 700 may include a plurality of interactive input fields 710-790 and a plurality of interactive buttons 701-702, while input field 710 and input field 790 may be similar to input field 410 and input field 440, respectively, in GUI 400, and interactive button 701 and interactive button 702 may be similar to interactive button 450 and interactive button 460, respectively, in GUI 400. Thus, redundant descriptions associated therewith may be omitted in below for conciseness.

Input fields 720-780 may be configured to receive user inputs for specifying or configuring the customized design option associated with the second stylistic category. Specifically, the input field 720 may be configured to receive an user input for selecting or specifying a font family which specifies a list of prioritized fonts and generic family names. The font family may include, for example, Roboto, Noto Sans, Times, Helvetica, and any other suitable font family.

The input field 730 may be configured to receive an user input for selecting or specifying a font style which defines whether or not a font should be configured with a specific style. The font style may include, for example, regular, italic, oblique, and any other suitable style.

The input field 740 may be configured to receive an user input for selecting or specifying a font size which defines the size of an associated font or text when being deployed in an associated application. The font size may be configured by the user by inserting a value into the input field 740. The font size may be configured in the unit of, for example, pixel (px), point (pt), percentage (%), root em (rem), and any other suitable unit.

The input field 750 may be configured to receive an user input for selecting or specifying a line height which defines the height of a line box and the distance between lines of text or font. The line height may be configured by the user by inserting a value into the input field 750. The line height may be configured in the unit of, for example, pixel (px), point (pt), percentage (%), ratio, and any other suitable unit.

The input field 760 may be configured to receive an user input for selecting or specifying a letter spacing which defines the horizontal spacing between text characters. The letter spacing may be configured by the user by inserting a value into the input field 760. The letter spacing may be configured in the unit of, for example, pixel (px), point (pt), percentage (%), root em (rem) ratio, and any other suitable unit. According to an embodiment, the value to be inputted into the input field 760 may be a positive value indicating that the texts or characters should be spread farther apart, or may be a negative value indicating that the texts or characters should be brought closer together.

The input field 770 may be configured to receive an user input for selecting or specifying a letter case configuration. The letter case configuration may be configured by the user by selecting (e.g., clicking) on a desired icon or option presented in input field 770 (although it can be understood that the icon or option may also be presented in a drop-down list or the like, without departing from the scope of the present disclosure). In the example embodiment illustrated in FIG. 7, four selectable letter case configurations are presented in input field 770 (although it can be understood that more or less selectable letter case configuration may be presented in input field 770, without departing from the scope of the present disclosure). For instance, by selecting not to have a specific letter case configuration (e.g., illustrated as icon “None” in input field 770), the letter case of texts or characters would not be automatically configured; by selecting a first configuration (e.g., illustrated as icon “AG” in input field 770), all texts or characters would be automatically presented in the form of larger uppercase or capitals; by selecting a second configuration (e.g., illustrated as icon “Ag” in input field 770), the first text or character (e.g., first in a line, first in a paragraph, etc.) would be automatically presented in the form of larger uppercase or capitals, while the subsequent text or character would be automatically presented in the form of smaller lowercase; and by selecting a third configuration (e.g., illustrated as icon “ag” in input field 770), all texts or characters would be automatically presented in to form of smaller lowercase. In the example embodiment illustrated in FIG. 7, the icon “None” is selected by the user, and thus the icon may presented in a distinguishing manner (e.g., filled with diagonal lines, etc.) from icons associated with other letter case configurations.

The input field 780 may be configured to receive an user input for selecting or specifying a decoration configuration which defines the appearance of decorative lines on a text or a character. The decoration configuration may be configured by the user by selecting (e.g., clicking) on a desired icon or option presented in input field 780 (although it can be understood that the icon or option may also be presented in a drop-down list or the like, without departing from the scope of the present disclosure). In the example embodiment illustrated in FIG. 7, three selectable decoration configurations are presented in input field 780 (although it can be understood that more or less selectable decoration configuration may be presented in input field 780, without departing from the scope of the present disclosure). For instance, by selecting not to have a specific decoration configuration (e.g., illustrated as icon “None” in input field 780), the decoration of texts or characters would not be automatically configured; by selecting a first configuration (e.g., illustrated as icon “U” in FIG. 7), all texts or characters would be automatically underlined; by selecting a second configuration (e.g., illustrated as icon “ [symbol] ” in FIG. 7), all texts or character would be automatically strikethrough. In the example embodiment illustrated in FIG. 7, the icon “U” is selected by the user, and thus the icon may presented in a distinguishing manner (e.g., filled with diagonal lines, etc.) from icons associated with other decoration configurations.

To this end, it can be understood that the information and interactive element(s) included in a GUI for managing (e.g., adding, modifying, etc.) a design option may vary according to the stylistic category. For instance, GUI 400, which is a GUI for adding a new customized color, may include input fields and icons specific to configuring or specification of “color”; while GUI 600, which is a GUI for adding a new typography, may include input fields and icons specific to configuring or specification of “typography”. In this way, the GUI(s) presented to the user may provide to the user appropriate and comprehensive information of the design option(s) according to the stylistic category, as well as to simplify the management of said design option(s) by providing the user appropriate guidance therefrom.

Further, it can be understood that one or more of the parameters in GUI 400 and GUI 700 may be automatically selected or populated by the App builder (or one or more modules included therein), according to one or more embodiments. For instance, the parameters in one or more of the input fields 410-440 of GUI 400 and/or the parameters in one or more of the input fields 710-790 may be automatically selected in default (e.g., when no user input is received via said input fields, etc.), based on the user's most frequently used line height setting, based on a line height requirement of a project associated with the user, and the like.

Furthermore, it can also be understood that the GUI 400 and GUI 700 may include one or more additional interactive elements to allow the user to further configure or further customize the design option. According to an embodiment, the GUI 400 and/or GUI 700 may include an interactive element associated with the configuration for sharing of the associated design option. For instance, the GUI 400 may include an text input field to allow the user to insert or input the information (e.g., name, ID, email address, etc.) of one or more users to which the customized color design option configured in GUI 400 is shared, the GUI 700 may include a drop-down list containing information of selectable user(s) (e.g., in term of personal user, group user, etc.) to which the customized typography design option configured in GUI 700 can be shared, and the like. The information required for configuring the sharing of a customized design option (e.g., information of one or more users, etc.) can be collected and processed in any suitable method or operation, without departing from the scope of the present disclosure.

Referring back to FIG. 7, upon configuring or specifying one or more configurations of the customized design option via the respective input field, the user may interact (e.g., clicking, etc.) with interactive element 702 (illustrated as a “Save” button in FIG. 7), and the App builder (or one or more modules included therein) may retrieve and collect said one or more configurations and generate a new customized charter based thereon. Subsequently, the App builder (or one or more modules included therein) may update one or more configuration profiles associated with the user to include the customized charter ID thereto, and may update one or more GUIs presented to the user (e.g., GUI 600) to include the information of the newly added customized design option.

FIG. 8 illustrates an example of updated GUI 800 for managing one or more design options associated with the second stylistic category. GUI 800 may be presented by the App builder (or one or more modules included therein) upon determining a user interaction on the interactive element 702 in FIG. 7. Further, GUI 800 may be an updated version of GUI 600 in FIG. 6 and may include one or more features, information, and interactive elements of GUI 600, and thus the redundant descriptions associated therewith may be omitted below for conciseness.

Referring to FIG. 8, the third partition 830 of GUI 800 may include an interactive block element 832 associated with the customized design option available to the user (e.g., customized typography design option added by the user via GUI 700 in FIG. 7, etc.). As illustrated in FIG. 8, in addition to the information and interactive elements included in block elements 621-623 (e.g., title/name, preview icon, edit icon, summary of configuration, copy icon, etc.), block element 832 may include an additional interactive element 832_1 which, when being interacted by the user, remove or delete the associated customized design option. Further, the third partition 830 of GUI 800 may include an interactive element 831 which, when being interacted by a user, generate and present one or more additional GUIs to allow the user to configure one or more configurations of the desired design option therefrom.

The function and operation associate with the interactive block element 832_1 and interactive element 831 may be similar to interactive block element 532_1 and interactive element 531 described above with reference to FIG. 5, thus redundant descriptions associated therewith may be omitted in below for conciseness.

To this end, the user may manage one or more design options associated with the second stylistic category (e.g., typography) via the above described GUI 600 to GUI 800. For instance, the user may add one or more new customized typography design, may edit or configure one or more available typography design options presented in the GUIs (e.g., edit the name of the pre-defined typography design options, change a font size of a customized typography design options, etc.), may remove one or more available customized typography design options, and the like.

It can be understood that “color” and “typography” described herein with reference to GUI 300 to GUI 800 (illustrated in FIG. 3 to FIG. 8, respectively) are merely two example stylistic categories for descriptive purpose, and the scope of the present disclosure should not be limited thereto. Specifically, example embodiments of the present disclosure may be applicable to management of any suitable stylistic design, and it is contemplated that the GUI(s) for managing design options of a different stylistic category may include one or more similar information or interactive element and/or one or more different information or interactive element from those illustrated in GUI 300 to GUI 800, without departing from the scope of the present disclosure.

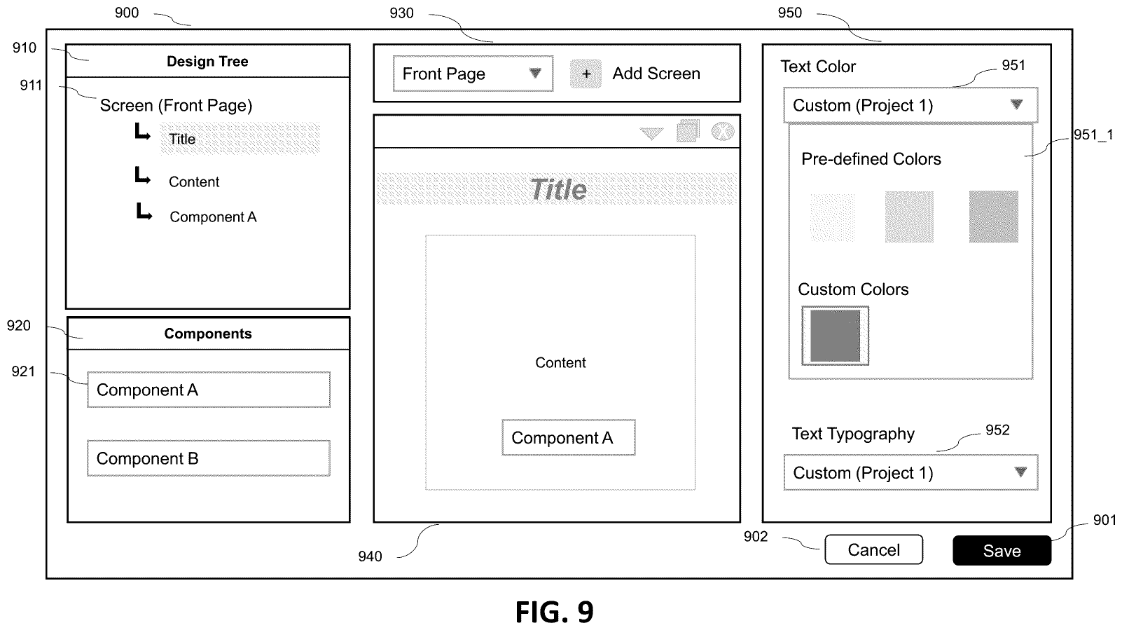

Next, referring to FIG. 9, which illustrates an example GUI 900 for utilizing one or more design options, according to one or more embodiments. GUI 900 may be presented to the user to allow the user to utilize one or more predefined design options and/or one or more customized design options to design an application.

For instance, GUI 900 may include customized design options added via GUI 400 and GUI 700 described above with reference to FIG. 4 and FIG. 7, respectively, so as to allow the user to select and implement said customized design options in the application. Furthermore, GUI 900 may be generated by the App builder (or one or more modules included therein) in response to a triggering event (e.g., a user interaction with an associated interactive element, etc.).

As illustrated in FIG. 9, GUI 900 may include a first partition 910, a second partition 920, a third partition 930, a fourth partition 940, and a fifth partition 950, as well as a first interactive element 901 and a second interactive element 902, although it is contemplated that GUI 900 may include more or less partition and/or interactive element without departing from the scope of the present disclosure.

The first partition 910 may include a listing containing one or more components selectable for designing. In the example embodiments illustrated in FIG. 9, the first partition 910 includes a listing 911 of available components (illustrated as “Title”, “Content”, and “Component A” in FIG. 9) which the user may select to design, and the first available component “Title” is selected.

The second partition 920 may include a plurality of interactive elements associated with available functional components. In the example embodiment illustrated in FIG. 9, the second partition 920 includes a plurality of interactive block elements 921, each of which may be selectable by the user to design the application. For instance, in the example embodiment illustrated in FIG. 9, the user may drag (e.g., click and hold, etc.) the interactive block elements of “component A”, “title”, and “content” from the second partition and drop said interactive block elements to a preview window (will be discussed below with reference to the fourth partition 940) and appropriately arrange the design of the application (e.g., arranging the location of said interactive block elements on the preview window, etc.).

The third partition 930 may include one or more interactive elements for managing one or more categories of the design targets. In the example embodiments illustrated in FIG. 9, the category of the design targets is “Screen”, and a first screen “Front Page” is selected by the user. In this regard, the third partition 930 may include a drop-down list which, when being interacted by the user, present a list of available screen(s) to the user for selection. Further, the third partition 930 may include a “+” button which, when being interacted by the user, present one or more GUIs to allow the user to add a new screen.

The fourth partition 940 may include a preview window showing a current design of the application. For instance, the user may drag-and-drop one or more functional components from the second partition 920 to the preview window, and may freely adjust the design of the functional components (e.g., adjust the size of each component, arrange the location of each component, etc.) therefrom. Further, the preview window may also show the current stylistic design associated with each of the components presented in the preview window (e.g., current color of the text associated with the component, current font size of text associated with the component, etc.).

The fifth partition 950 may include one or more interactive elements for managing or configuring the stylistic design of the component selected in the first partition 910. For instance, the fifth partition 950 may include one or more drop-down lists which, when being interacted by the user, present a listing of available design options (e.g., available pre-defined design options, available customized design options, etc.) for user selection. In the example embodiments illustrated in FIG. 9, the fifth portion 950 includes a first drop-down list 951 associated with color (e.g., first stylistic category) and a second drop-down list 952 associated with typography (e.g., second stylistic category), and a listing 951_1 containing pre-defined color design options and customized color design option (e.g., added by the user via GUI 400, etc.) is presented in response to a user interaction with the drop-down list 951. It can be understood that the available typography design options may be presented and selectable by the user in a similar manner.

In this example embodiment, since the “Title” component (which constitutes of texts) are selected as the target for designing, the design options presented in the fifth partition 950 allow the user to design the texts of the “Title” component (e.g., change the text color, adjust the font family, etc.). In some embodiments in which design on typography or color is not required, the fifth partition 950 may present only the required or applicable design options. For instance, if the user has selected “Content” component for designing, and would like to utilize the “Content” as the background (without containing any text), the fifth partition 950 may present only available color design options to allow the user to design the background color, without presenting the typography design options.

It is contemplated that the above described GUI 300 to GUI 900, as well as the descriptions associated therewith, are merely example embodiments provided herein for descriptive purpose, and should not in any means restrict the scope of the present disclosure. Specifically, one or more of said GUI 300 to GUI 900 may be arranged in a different manner, may include more or less features and/or information as compared to those as described, and the operations associated therewith may be performed in a different manner, without departing from the scope of the present disclosure.

Ultimately, example embodiments of present disclosure provide comprehensive information associated with the one or more design options of one or more stylistic categories, and allow a user to easily manage (e.g., configure, add, remove, etc.) and utilize said one or more design options.

### Customized Design Charter and Configuration Profile

As discussed above, the App builder (or one or more modules included therein) may manage (e.g., generate, update, share, remove, etc.) a customized design charter (may be referred to as “customized charter” herein) based on one or more user inputs.

According to an embodiment, the customized charter may include a customized charter ID and configurations of an associated customized design option. The customized charter ID may be automatically generated by the App builder (e.g., module 112) based on an user input (e.g., a text inputted by the user in the text field defining the name of the design option, etc.).

Further, the customized charter ID may be a hypertext (or any other suitable format) which may interconnect the customized charter with an interactive element and the associated configuration profile. In this way, whenever the user changes the configuration of the customized design option (e.g., changes the name of the customized design option, etc.), said changes will be automatically reflected in the customized charter as well as in the configuration profile.

FIG. 10 illustrates examples of customized design charter, according to one or more embodiments. In this regard, table 1010 illustrates a customized charter associated with a customized color design option, and table 1020 illustrates a customized charter associated with a customized typography design option.

According to another embodiment, one customized charter may be generated for a user or for a group of users. For example, a plurality of customized design options associated with a user or a group of users may be compiled in one customized charter, without departing from the scope of the present disclosure.

Further, as also discussed above with reference to FIG. 2, when generating the customized charter, the App builder (or one or more modules included therein) may update an associated configuration profile. The configuration profile may be created by the App builder (or one or more modules included therein) and be assigned to the user whenever the user creates a new project or shares the configuration with other users (e.g., other team member, a friend, etc.).

FIG. 11 illustrates an example of a configuration profile, according to one or more embodiments. Referring to FIG. 11, the configuration profile may include a configuration profile ID, one or more source charter IDs, and one or more customized charter IDs, although it can be understood that the configuration profile may include any other suitable information without departing from the scope of present disclosure. The configuration profile ID may be automatically generated by the App builder whenever the user create a new project or share the configuration with other users (e.g., other team member, a friend, etc.). The source charter ID may be automatically selected by the App builder based on the type of application or project, and/or may be manually added by the user. The customized charter ID may be automatically included or updated by the App builder (e.g., module 112) whenever an associated customized charter is created or is updated. In the case there is no customized charter available to the user (e.g., the user is new to the system, the user has deleted all associated customized design option, etc.), the “customized charter ID” in the configuration profile may be left empty, may be auto-filled by a default parameter, and the like.

The configuration profile may be stored in storage module 120 and may be retracted therefrom when required. For instance, whenever a user has successfully login to the system, module 111 may receive the user information (e.g., user ID, etc.) from module 113, and may continuously or periodically obtain the configuration profile(s) associated with the user from the storage module 120 based on the user information. For example, module 111 may obtain the configuration profile from the storage module based on a mapping of user ID and configuration profile ID, as illustrated in FIG. 12. Accordingly, module 111 may continuously or periodically determine which design charter(s) is available to the user, may obtain the design charter(s) from storage module 120, and may generate a listing containing the most recent or updated available design options based on the obtained design charter(s).

On the other hand, whenever a user has created or modified a customized design option via one or more GUIs, the module 112 may receive the user information (e.g., user ID), along with one or more user inputs defining the customized design option, from module 113. Accordingly, module 112 may generate or update a customized charter associated with the customized design option. In this regard, based on determining that it is required to update the associated configuration profile (e.g., based on determining that a new customized charter is created, based on determining that a change in the customized charter ID is made, etc.), module 112 may obtain the associated configuration profile from storage module 120 (e.g., when storing the customized charter to storage module 120, etc.) and may update the associated configuration profile accordingly (e.g., include the ID of the new customized charter, update ID of existing customized charter, etc.). In this way, any changes in the customized charter may be automatically and timely updated and reflected.

It is contemplated that the tables illustrated in FIG. 10 to FIG. 12 and the associated descriptions provided hereinabove are merely example embodiments for descriptive purpose, and one or more of the customized charter, the configuration profile, and the mapping may have a different arrangement without departing from the scope of the present disclosure. For instance, it can be understood that the information illustrated in said tables can also be in any suitable format (instead of table format), may include more or less information, and may be arranged in different manner, without departing from the scope of the present disclosure.

### Sharing of a Customized Design Option

According to an embodiment, a user may share a customized design option to one or more users (e.g., a user working on the same project, a user under the same team, a friend, etc.). For instance, when creating or modifying a customized design option, the user may choose (e.g., via the respective GUI, etc.) whether or not said customized design option shall be shared to another user(s).

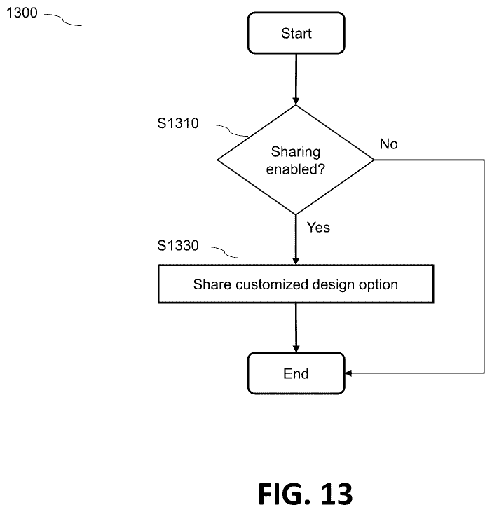

FIG. 13 illustrates a block diagram of a method 1300 for sharing a customized design option, according to one or more embodiments. Method 1300 may be performed by App builder 110 (or one or more modules included therein).

Referring to FIG. 13, at operation 1300, the App builder may determine whether or not the sharing of the customized design option is enabled. For instance, according to an embodiment, the GUIs for managing customized design option (e.g., GUIs illustrated in FIG. 3 to FIG. 8, etc.) may include an interactive element (e.g., a button, a drop-down list, etc.) to allow the user to disable or enable the sharing of the customized design option by interacting with the interactive element. Subsequently, the module 113 may receive the associated user input from the GUI and provide the same to module 112. Based on the received user input, the module 112 may determine whether or not the sharing of the customized design option is enabled.

In some embodiments, based on determining that the user has not interacted with said interactive element (e.g., user has not specified whether or not the sharing of the customized design option is enabled or is disabled), the App builder (e.g., module 113, module 112, etc.) may assume that the user would not like to share the customized design option in default and may automatically determine that the sharing of the customized design option is not enabled (i.e., is disabled). Conversely, in some embodiments, based on determining that the user has not interacted with said interactive element (e.g., user has not specified whether or not the sharing of the customized design option is enabled or is disabled), the App builder (e.g., module 113, module 112, etc.) may assume that the user would like to share the customized design option in default and may automatically determine that the sharing of the customized design option is enabled.

Based on determining that the sharing of the customized design option is enabled, the process proceeds to operation S1330, at which the customized design option is shared to one or more associated users.

Specifically, whenever the user choose to enable the sharing of the customized design option, the user may specify one or more users to which the customized design option should be shared. According to an embodiment, the GUI (from which the user manage the customized design option and enable the sharing of the customized design option) may include an interactive element (e.g., text input field, drop-down list, etc.) to allow the user to specify to which user(s) the customized design option should be shared. Accordingly, based on the user input(s), the module 112 may generate or update the associated customized charter and configuration profile.

By way of example, referring back to FIG. 10. In this example embodiment, the user has two customized charters (e.g., 1010 and 1020) associated therewith, and the user has disabled the sharing of customized design option associated with customized charter 1010 and has enabled the sharing of customized design option associated with customized charter 1020 to user 0002 only. Thus, module 112 may configure or update customized charters 1010 and 1020 to include information or said configuration.

Further, the module 112 may generate or update configuration profile of the associated users accordingly. FIG. 14 illustrates an example of updated configuration profiles, according to one or more embodiments. The configuration profiles may be generated by the module 112 based on existing configuration profiles (e.g., configuration profile illustrated in FIG. 11, etc.) and mapping of user ID and configuration profile ID (e.g., mapping illustrated in FIG. 12, etc.).

Referring to FIG. 14, configuration profile 1410 may be associated with a user 0001 (i.e., the user who has created or managed the customized design option). In this regard, the ID of both customized charters 1010 and 1020 (in FIG. 10) may be included in configuration profile 1410, such that the customized design options associated with said customized charters will always be available to user 0001.

On the other hand, configuration profile 1420 may be associated with a user 0002, and configuration profile 1430 may be associated with a user 0003. In this regard, since user 0001 has disabled the sharing of customized design option associated with customized charter 1010 and has only enabled the sharing of customized design option associated with customized charter 1020 with user 0002, the module 112 may include only the ID of customized charter 1020 in configuration profile 1420, while not including ID of any of customized charters 1010 and 1020 in configuration profile 1430. Accordingly, customized design option associated with customized charter 1010 may only be available to user 0001, and customized design option associated with customized charter 1020 will be shared with only user 0002.

According to an embodiment, a user who is not the creator or manager of the customized design option may be allowed to share the customized design option to another user. For instance, the creator or manager of the customized design option may authorize another user(s) to share the customized design option to other user(s). Alternatively, the system may automatically enable a user to share a customized design option to which the user has access.

It can be understood that the configuration profiles illustrated in FIG. 14 are merely example embodiments for descriptive purpose, and the configuration profiles may be arranged in a different manner to allow the sharing of customized design option, without departing from the scope of present disclosure.

To this end, the example embodiments of the present disclosures allow a user to easily share one or more customized design option to one or more associated users (e.g., users working on a same project, users from the same team, etc.), while effectively improve the information security since the customized design option will not be accessible to non-associated users.

### Changing of a Customized Design Option

According to an embodiment, a user may change or modify a customized design option, and said change or modification may be automatically applied to one or more associated users and one or more associated applications which have utilized the customized deign option.

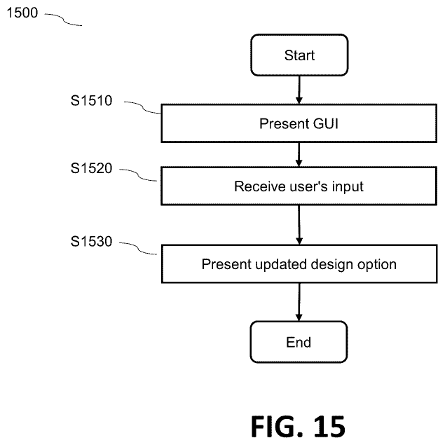

FIG. 15 illustrates a block diagram of a method 1500 for changing a customized design option, according to one or more embodiments. One or more operations of method 1500 may be similar to those described above with reference to method 200 of FIG. 2, thus redundant descriptions associated therewith may be omitted below for conciseness.

Referring to FIG. 15, at operation S1510, one or more GUIs are presented to a user. For instance, a GUI for managing one or more customized design options may be presented to the user. The GUI may be similar to the one illustrated in FIG. 5 and FIG. 8 as described above, thus redundant descriptions associated therewith may be omitted below for conciseness.

At operation S1520, one or more user inputs are received. The process may be similar to operation S220 described above with reference to FIG. 2, thus redundant descriptions associated therewith may be omitted below for conciseness.

In this regard, based on determining that the user input is an interaction with an interactive element associated with the function for modifying a customized design option (e.g., clicking on an edit button, etc.), the module 113 may generate and present another GUI (e.g., in the form of pop-out sub-window, etc.) to the user, so as to receive additional user inputs for changing or modifying the customized design option therefrom. Said another GUI may be similar to the GUIs illustrated in FIG. 4 and FIG. 7, thus redundant descriptions associated therewith may be omitted below for conciseness.

At operation S1530, the App builder 110 (or one or more modules included therein) may update the GUI to present the updated customized design option based on the user input.

For instance, the module 113 may provide the received user input(s) to module 112, module 112 may update the associated customized charter. Accordingly, module 111 may retrieve the updated customized charter and generate a listing comprises the updated customized design option, and may provide the listing to module 113 such that module 113 can generate an updated GUI including the updated customized design option.

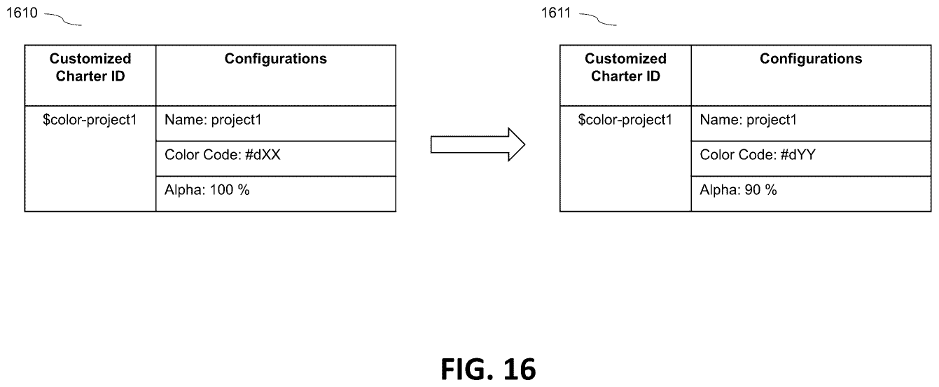

FIG. 16 illustrates an example use case of changing a customized design option, according to one or more embodiment. In this example use case, the user has changed or modified the configurations of the customized design option, without affecting the customized charter ID.

Referring to FIG. 16, customized charter 1610 is a customized charter for an customized color design option. In this example user case, the user has changed or modified the color code from “#dXX” to “#dYY” and has changed or modified the alpha from “100%” to “90%”. Since said changes do not affect the customized charter ID, the module 112 may simply update the customized charter 1610 accordingly. The updated customized charter is illustrated in customized charter 1611.

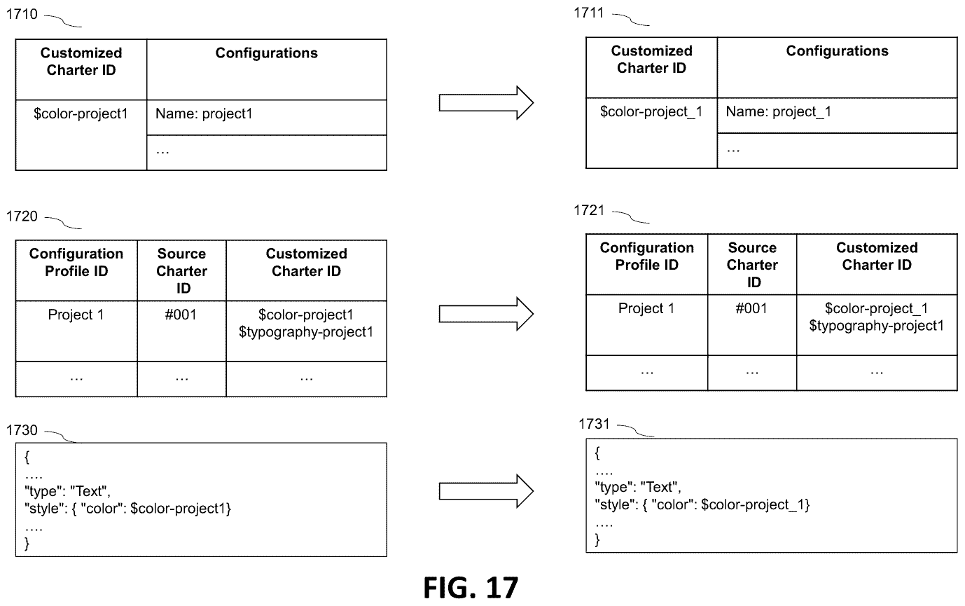

FIG. 17 illustrates another example use case of changing a customized design option, according to one or more embodiments. In this example use case, the user has changed or modified the configurations of the same customized design option as described in the example use case of FIG. 16, and the changes and modification may affect the customized charter ID.

Referring to FIG. 17, customized charter 1710 is a customized charter for an customized color design option, which may be similar to customized charter 1610 in FIG. 16. In this example use case, the user has changed the name of the customized design option from “project1” to “project_1”.

According to an embodiment, the changes in the name of the customized design option does not affect the customized charter ID, and the module 112 may simply update the customized charter without changing the customized charter ID, in a similar manner described above with reference to FIG. 16.

According to another embodiment, the name of the customized design option may be generated in the form of hypertext and may be associated (or interconnected) with the customized charter ID. In that case, the customized charter ID will be concurrently updated (e.g., by the module 112) according to the updated name of the customized design option. For instance, as illustrated in FIG. 17, customized charter ID of customized charter 1710 are updated from “$color-project1” (as illustrated in customized charter 1710) to “$color-project_1” (as illustrated in updated customized charter 1711), according to the changes made on the name of the customized design option.

Further, the customized charter ID included in the customized charter may also be generated in the form of hypertext and may be associated (or interconnected with) the customized charter ID included in the configuration profile(s) and/or the customized charter ID in the programming codes of the application which has utilized the customized design charter. In that case, the customized charter ID in the configuration profile(s) and/or the customized charter ID in the programming codes may be concurrently updated (e.g., by the module 112) according to the updated name of the customized design option.

Referring to FIG. 17, configuration profile 1720 includes the customized charter ID similar to the customized charter ID of customized charter 1710 (before the name of the customized design option is changed by the user). Subsequently, upon determining a change in the customized charter ID of the associated customized charter, the customized charter ID of the configuration profile may be updated according to the changes. For instance, in the example use case of FIG. 17, the customized charter ID of configuration profile 1720 is updated from “$color-project 1” to “$color-project_1”, which is consistent with the updated customized charter ID in the updated customized charter 1711.

The customized charter ID of the programming codes may be updated in a similar manner. For instance, in the example use case of FIG. 17, the portion of programming codes which is associated with the customized charter ID is updated according to the changes in the customized ID of the associated customized charter. Specifically, the customized charter ID of associated portion 1730 is updated (by the App builder 110 or a suitable module included therein) from “$color-project1” to “$color-project_1”, which is consistent with the updated customized charter ID in the updated customized charter 1711.

According to an embodiment, only authorized user(s) (i.e., user(s) authorized by the creator or manager of the customized design option) may change or modify a customized design option. According to another embodiment, all user(s) which has access to the customized design option may change or modify the customized design option. In this regard, an unauthorized user(s) may change or modify the customized design option, and the App builder may request authorization from the creator or manager of the customized design option before updating the associated customized charter, configuration profile, and/or programming codes. If the creator or manager of the customized design option agree with the changes and allow the changes to be updated in the associated customized charter, configuration profile, and/or programming codes, the App builder may update said information accordingly.

In view of the above, example embodiments of the present disclosure allow a user to easily update a customized design option. Specifically, whenever the user has made a change or a modification on the customized design option, said change or modification may be automatically applied to the associated information (e.g., customized charter, configuration profile, programming codes, etc.). Accordingly, the system may automatically perform the required update(s) based on the user's change or modification, which in turns reduce the user's burden in updating the stylistic design, improve the efficiency and effectiveness in managing the changes or modification in the stylistic design option, and reduce the risk of introducing errors.

### Implementation Environment and Device

FIG. 18 is a diagram of an example environment 1800 in which systems and/or methods, described herein, may be implemented. As shown in FIG. 18, environment 1800 may include a user device 1810, a platform 1820, and a network 1830. Devices of environment 1800 may interconnect via wired connections, wireless connections, or a combination of wired and wireless connections. In embodiments, any of the functions and operations described with reference to FIG. 1 to FIG. 17 above may be performed by any combination of elements illustrated in FIG. 18.

User device 1810 includes one or more devices capable of receiving, generating, storing, processing, and/or providing information associated with platform 1820. For example, user device 1810 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 1810 may receive information from and/or transmit information to platform 1820.

Platform 1820 includes one or more devices capable of receiving, generating, storing, processing, and/or providing information. In some implementations, platform 1820 may include a cloud server or a group of cloud servers. In some implementations, platform 1820 may be designed to be modular such that certain software components may be swapped in or out depending on a particular need. As such, platform 1820 may be easily and/or quickly reconfigured for different uses.

In some implementations, as shown, platform 1820 may be hosted in cloud computing environment 1822. Notably, while implementations described herein describe platform 1820 as being hosted in cloud computing environment 1822, in some implementations, platform 1820 may not be cloud-based (i.e., may be implemented outside of a cloud computing environment) or may be partially cloud-based.

Cloud computing environment 1822 includes an environment that hosts platform 1820. Cloud computing environment 1822 may provide computation, software, data access, storage, etc. services that do not require end-user (e.g., user device 1810) knowledge of a physical location and configuration of system(s) and/or device(s) that hosts platform 1820. As shown, cloud computing environment 1822 may include a group of computing resources 1824 (referred to collectively as “computing resources 1824” and individually as “computing resource 1824”).

Computing resource 1824 includes one or more personal computers, a cluster of computing devices, workstation computers, server devices, or other types of computation and/or communication devices. In some implementations, computing resource 1824 may host platform 1820. The cloud resources may include compute instances executing in computing resource 1824, storage devices provided in computing resource 1824, data transfer devices provided by computing resource 1824, etc. In some implementations, computing resource 1824 may communicate with other computing resources 1824 via wired connections, wireless connections, or a combination of wired and wireless connections.

As further shown in FIG. 18, computing resource 1824 includes a group of cloud resources, such as one or more applications (“APPs”) 1824-1, one or more virtual machines (“VMs”) 1824-2, virtualized storage (“VSs”) 1824-3, one or more hypervisors (“HYPs”) 1824-4, or the like.

Application 1824-1 includes one or more software applications that may be provided to or accessed by user device 1810. Application 1824-1 may eliminate a need to install and execute the software applications on user device 1810. For example, application 1824-1 may include software associated with platform 1820 and/or any other software capable of being provided via cloud computing environment 1822. In some implementations, one application 1824-1 may send/receive information to/from one or more other applications 1824-1, via virtual machine 1824-2.

Virtual machine 1824-2 includes a software implementation of a machine (e.g., a computer) that executes programs like a physical machine. Virtual machine 1824-2 may be either a system virtual machine or a process virtual machine, depending upon use and degree of correspondence to any real machine by virtual machine 1824-2. A system virtual machine may provide a complete system platform that supports execution of a complete operating system (“OS”). A process virtual machine may execute a single program, and may support a single process. In some implementations, virtual machine 1824-2 may execute on behalf of a user (e.g., user device 1810), and may manage infrastructure of cloud computing environment 1822, such as data management, synchronization, or long-duration data transfers.

Virtualized storage 1824-3 includes one or more storage systems and/or one or more devices that use virtualization techniques within the storage systems or devices of computing resource 1824. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 1824-4 may provide hardware virtualization techniques that allow multiple operating systems (e.g., “guest operating systems”) to execute concurrently on a host computer, such as computing resource 1824. Hypervisor 1824-4 may present a virtual operating platform to the guest operating systems, and may manage the execution of the guest operating systems. Multiple instances of a variety of operating systems may share virtualized hardware resources.

Network 1830 includes one or more wired and/or wireless networks. For example, network 1830 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 18 are provided as an example. In practice, there may be additional devices and/or networks, fewer devices and/or networks, different devices and/or networks, or differently arranged devices and/or networks than those shown in FIG. 18. Furthermore, two or more devices shown in FIG. 18 may be implemented within a single device, or a single device shown in FIG. 18 may be implemented as multiple, distributed devices. Additionally, or alternatively, a set of devices (e.g., one or more devices) of environment 1800 may perform one or more functions described as being performed by another set of devices of environment 1800.

FIG. 19 is a diagram of example components of a device 1900. As shown in FIG. 19, device 1900 may include a bus 1910, a processor 1920, a memory 1930, a storage component 1940, an input component 1950, an output component 1960, and a communication interface 1970. In embodiments, any of the functions and operations described with reference to FIG. 1 to FIG. 17 above may be performed by any combination of elements illustrated in FIG. 19.

Bus 1910 includes a component that permits communication among the components of device 1900. Processor 1920 may be implemented in hardware, firmware, or a combination of hardware and software. Processor 1920 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 2190 includes one or more processors capable of being programmed to perform a function. Memory 1930 includes a random access memory (RAM), a read only memory (ROM), and/or another type of dynamic or static storage device (e.g., a flash memory, a magnetic memory, and/or an optical memory) that stores information and/or instructions for use by processor 1920.

Storage component 1940 stores information and/or software related to the operation and use of device 1900. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 1950 includes a component that permits device 1900 to receive information, such as via user input (e.g., a touch screen display, a keyboard, a keypad, a mouse, a button, a switch, and/or a microphone). Additionally, or alternatively, input component 1950 may include a sensor for sensing information (e.g., a global positioning system (GPS) component, an accelerometer, a gyroscope, and/or an actuator). Output component 1960 includes a component that provides output information from device 1900 (e.g., a display, a speaker, and/or one or more light-emitting diodes (LEDs)).

Communication interface 1970 includes a transceiver-like component (e.g., a transceiver and/or a separate receiver and transmitter) that enables device 1900 to communicate with other devices, such as via a wired connection, a wireless connection, or a combination of wired and wireless connections. Communication interface 1970 may permit device 1900 to receive information from another device and/or provide information to another device. For example, communication interface 1970 may include an Ethernet interface, an optical interface, a coaxial interface, an infrared interface, a radio frequency (RF) interface, a universal serial bus (USB) interface, a Wi-Fi interface, a cellular network interface, or the like.

Device 1900 may perform one or more processes described herein. Device 1900 may perform these processes in response to processor 1920 executing software instructions stored by a non-transitory computer-readable medium, such as memory 1930 and/or storage component 1940. A computer-readable medium is defined herein as a non-transitory memory device. A memory device includes memory space within a single physical storage device or memory space spread across multiple physical storage devices.

Software instructions may be read into memory 1930 and/or storage component 1940 from another computer-readable medium or from another device via communication interface 1970. When executed, software instructions stored in memory 1930 and/or storage component 1940 may cause processor 1920 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 19 are provided as an example. In practice, device 1900 may include additional components, fewer components, different components, or differently arranged components than those shown in FIG. 19. Additionally, or alternatively, a set of components (e.g., one or more components) of device 1900 may perform one or more functions described as being performed by another set of components of device 900.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

### VARIOUS ASPECTS OF EMBODIMENTS

Various further respective aspects and features of embodiments of the present disclosure may be defined by the following items:

Item [1]: An apparatus including: at least one memory storage storing computer-executable instructions; and at least one processor communicatively coupled to the memory storage, wherein the at least one processor may be configured to execute the computer-executable instructions to: present, to a user, a first graphical user interface (GUI) including information of a stylistic category; receive, from the user via the first GUI, a user input for managing a customized design option associated with the stylistic category; and manage the customized design option based on the user input.

Item [2]: The apparatus according to item 1, wherein the at least one processor may be configured to execute the computer-executable instructions to present the first GUI by: obtaining at least one source design charter associated with the stylistic category; generating a listing including at least one design option predefined by the source design charter; generating, based on the listing, the first GUI; and providing the first GUI to a user terminal associated with the user.

Item [3]: The apparatus according to any one of items [1]-[2], wherein the first GUI includes a plurality of interactive elements, each of which may be associated with an operation for managing the customized design option, wherein the user input may include a user interaction with at least one interactive element of the plurality of interactive elements, and wherein the at least one processor may be configured to execute the computer-executable instructions to manage the customized design option by: determining, based on the user input, the operation associated with the interactive element with which the user has interacted; and performing the operation to manage the customized user input.

Item [4]: The apparatus according to item 3, wherein the at least one processor may be further configured to execute the computer-executable instructions to manage the customized design option by: based on determining that the operation is a creation of a new customized design option, presenting, to the user, a second GUI including one or more interactive elements for specifying the configuration of the new customized design option; receiving, from the user via the second GUI, a user interaction with the one or more interactive elements; generating, based on the user interaction, a new customized design charter, wherein the new customized design charter may define the user-specified configuration of the new customized design option; and updating, based on the new customized design charter, the first GUI to include information associated with the new customized design option.

Item [5]: The apparatus according to item 3, wherein the at least one processor may be further configured to execute the computer-executable instructions to manage the customized design option by: based on determining that the operation is a modification of an existing customized design option, presenting, to the user, a second GUI including information associated with the existing customized design option and one or more interactive elements for modifying the existing customized design option; receiving, from the user via the second GUI, a user interaction with the one or more interactive elements; updating, based on the user interaction, a customized design charter associated with the existing customized design option, wherein the updated customized design charter may define a modified customized design option; and updating, based on the updated customized design charter, the first GUI to include information associated with the modified customized design option.

Item [6]: The apparatus according to item [3], wherein the at least one processor may be further configured to execute the computer-executable instructions to manage the customized user input by: based on determining that the operation is a sharing of an existing customized design option, presenting, to the user, a second GUI including information associated with the existing customized design option and one or more interactive elements for specifying at least one user to which the existing customized design option should be shared; receiving, from the user via the second GUI, a user interaction with the one or more interactive elements; obtaining, based on the user interaction, at least one configuration profile associated with the at least one user; and updating the at least one configuration profile to include an ID of a customized design charter associated with the existing customized design option.

Item [7]: The apparatus according to any one of items [1]-[6], wherein the stylistic category may be a color category.

Item [8]: The apparatus according to any one of items [1]-[6], wherein the stylistic category may be a typography category.

Item [9]: A method, performed by at least one processor, including: presenting, to a user, a first graphical user interface (GUI) including information of a stylistic category; receiving, from the user via the first GUI, a user input for managing a customized design option associated with the stylistic category; and managing the customized design option based on the user input.

Item [10]: The method according to item [9], wherein the presenting of the first GUI may include: obtaining at least one source design charter associated with the stylistic category; generating a listing including at least one design option predefined by the source design charter; generating, based on the listing, the first GUI; and providing the first GUI to a user terminal associated with the user.

Item [11]: The method according to any one of items [9]-[10], wherein the first GUI may include a plurality of interactive elements, each of which is associated with an operation for managing the customized design option, wherein the user input may include a user interaction with at least one interactive element of the plurality of interactive elements, and wherein the managing the customized design option may include: determining, based on the user input, the operation associated with the interactive element with which the user has interacted; and performing the operation to manage the customized user input.

Item [12]: The method according to item [11], wherein the managing the customized design option may further include: based on determining that the operation is a creation of a new customized design option, presenting, to the user, a second GUI including one or more interactive elements for specifying the configuration of the new customized design option; receiving, from the user via the second GUI, a user interaction with the one or more interactive elements; generating, based on the user interaction, a new customized design charter, wherein the new customized design charter may define the user-specified configuration of the new customized design option; and updating, based on the new customized design charter, the first GUI to include information associated with the new customized design option.

Item [13]: The method according to item [11], wherein the managing the customized design option may further include: based on determining that the operation is a modification of an existing customized design option, presenting, to the user, a second GUI including information associated with the existing customized design option and one or more interactive elements for modifying the existing customized design option; receiving, from the user via the second GUI, a user interaction with the one or more interactive elements; updating, based on the user interaction, a customized design charter associated with the existing customized design option, wherein the updated customized design charter defines a modified customized design option; and updating, based on the updated customized design charter, the first GUI to include information associated with the modified customized design option.

Item [14]: The method according to item [11], wherein the managing the customized design option may further include: based on determining that the operation is a sharing of an existing customized design option, presenting, to the user, a second GUI including information associated with the existing customized design option and one or more interactive elements for specifying at least one user to which the existing customized design option should be shared; receiving, from the user via the second GUI, a user interaction with the one or more interactive elements; obtaining, based on the user interaction, at least one configuration profile associated with the at least one user; and updating the at least one configuration profile to include an ID of a customized design charter associated with the existing customized design option.

Item [15]: The method according to any one of items [9]-[14], wherein the stylistic category may include a color category.

Item [16]: The method according to any one of items [9]-[14], wherein the stylistic category may include a typography category.

Item [17]: A non-transitory computer-readable recording medium having recorded thereon instructions executable by at least one processor to cause the at least one processor to perform a method including: presenting, to a user, a first graphical user interface (GUI) including information of a stylistic category; receiving, from the user via the first GUI, a user input for managing a customized design option associated with the stylistic category; and managing the customized design option based on the user input.

Item [18]: The non-transitory computer-readable recording medium according to item [17], wherein the presenting the first GUI may include: obtaining at least one source design charter associated with the stylistic category; generating a listing including at least one design option predefined by the source design charter; generating, based on the listing, the first GUI; and providing the first GUI to a user terminal associated with the user.

Item [19]: The non-transitory computer-readable recording medium according to any one of items [17]-[18], wherein the first GUI may include a plurality of interactive elements, each of which is associated with an operation for managing the customized design option, wherein the user input may include a user interaction with at least one interactive element of the plurality of interactive elements, and wherein the managing the customized design option may include: determining, based on the user input, the operation associated with the interactive element with which the user has interacted; and performing the operation to manage the customized user input.

Item [20]: The non-transitory computer-readable recording medium according to item [19], wherein the managing the customized design option may further include: based on determining that the operation is a creation of a new customized design option, presenting, to the user, a second GUI including one or more interactive elements for specifying the configuration of the new customized design option; receiving, from the user via the second GUI, a user interaction with the one or more interactive elements; generating, based on the user interaction, a new customized design charter, wherein the new customized design charter may define the user-specified configuration of the new customized design option; and updating, based on the new customized design charter, the first GUI to include information associated with the new customized design option.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. An apparatus comprising:
at least one memory storage storing computer-executable instructions; and
at least one processor communicatively coupled to the memory storage, wherein the at least one processor is configured to execute the computer-executable instructions to:
present, to a user, a first graphical user interface (GUI) comprising information of a stylistic category;
receive, from the user via the first GUI, a user input for managing a customized design option associated with the stylistic category; and
manage the customized design option based on the user input.

2. The apparatus as claimed in claim 1, wherein the at least one processor is configured to execute the computer-executable instructions to present the first GUI by:
obtaining at least one source design charter associated with the stylistic category;
generating a listing including at least one design option predefined by the source design charter;
generating, based on the listing, the first GUI; and
providing the first GUI to a user terminal associated with the user.

3. The apparatus as claimed in claim 1, wherein the first GUI comprises a plurality of interactive elements, each of which is associated with an operation for managing the customized design option, wherein the user input comprises a user interaction with at least one interactive element of the plurality of interactive elements, and wherein the at least one processor is configured to execute the computer-executable instructions to manage the customized design option by:
determining, based on the user input, the operation associated with the interactive element with which the user has interacted; and
performing the operation to manage the customized user input.

4. The apparatus as claimed in claim 3, wherein the at least one processor is further configured to execute the computer-executable instructions to manage the customized design option by:
based on determining that the operation is a creation of a new customized design option, presenting, to the user, a second GUI comprising one or more interactive elements for specifying the configuration of the new customized design option;
receiving, from the user via the second GUI, a user interaction with the one or more interactive elements;
generating, based on the user interaction, a new customized design charter, wherein the new customized design charter defines the user-specified configuration of the new customized design option; and
updating, based on the new customized design charter, the first GUI to include information associated with the new customized design option.

5. The apparatus as claimed in claim 3, wherein the at least one processor is further configured to execute the computer-executable instructions to manage the customized design option by:
based on determining that the operation is a modification of an existing customized design option, presenting, to the user, a second GUI comprising information associated with the existing customized design option and one or more interactive elements for modifying the existing customized design option;
receiving, from the user via the second GUI, a user interaction with the one or more interactive elements;
updating, based on the user interaction, a customized design charter associated with the existing customized design option, wherein the updated customized design charter defines a modified customized design option; and
updating, based on the updated customized design charter, the first GUI to include information associated with the modified customized design option.

6. The apparatus as claimed in claim 3, wherein the at least one processor is further configured to execute the computer-executable instructions to manage the customized design option by
based on determining that the operation is a sharing of an existing customized design option, presenting, to the user, a second GUI comprising information associated with the existing customized design option and one or more interactive elements for specifying at least one user to which the existing customized design option should be shared;
receiving, from the user via the second GUI, a user interaction with the one or more interactive elements;
obtaining, based on the user interaction, at least one configuration profile associated with the at least one user; and
updating the at least one configuration profile to include an ID of a customized design charter associated with the existing customized design option.

7. The apparatus as claimed in claim 1, wherein the stylistic category is a color category.

8. The apparatus as claimed in claim 1, wherein the stylistic category is a typography category.

9. A method, performed by at least one processor, comprising:
presenting, to a user, a first graphical user interface (GUI) comprising information of a stylistic category;
receiving, from the user via the first GUI, a user input for managing a customized design option associated with the stylistic category; and
managing the customized design option based on the user input.

10. The method as claimed in claim 9, wherein the presenting of the first GUI comprises:
obtaining at least one source design charter associated with the stylistic category;
generating a listing including at least one design option predefined by the source design charter;
generating, based on the listing, the first GUI; and
providing the first GUI to a user terminal associated with the user.

11. The method as claimed in claim 9, wherein the first GUI comprises a plurality of interactive elements, each of which is associated with an operation for managing the customized design option, wherein the user input comprises a user interaction with at least one interactive element of the plurality of interactive elements, and wherein the managing the customized design option comprises:
determining, based on the user input, the operation associated with the interactive element with which the user has interacted; and
performing the operation to manage the customized user input.

12. The method as claimed in claim 11, wherein the managing the customized design option further comprises:
based on determining that the operation is a creation of a new customized design option, presenting, to the user, a second GUI comprising one or more interactive elements for specifying the configuration of the new customized design option;
receiving, from the user via the second GUI, a user interaction with the one or more interactive elements;
generating, based on the user interaction, a new customized design charter, wherein the new customized design charter defines the user-specified configuration of the new customized design option; and
updating, based on the new customized design charter, the first GUI to include information associated with the new customized design option.

13. The method as claimed in claim 11, wherein the managing the customized design option further comprises:
based on determining that the operation is a modification of an existing customized design option, presenting, to the user, a second GUI comprising information associated with the existing customized design option and one or more interactive elements for modifying the existing customized design option;
receiving, from the user via the second GUI, a user interaction with the one or more interactive elements;
updating, based on the user interaction, a customized design charter associated with the existing customized design option, wherein the updated customized design charter defines a modified customized design option; and
updating, based on the updated customized design charter, the first GUI to include information associated with the modified customized design option.

14. The method as claimed in claim 11, wherein the managing the customized design option further comprises:
based on determining that the operation is a sharing of an existing customized design option, presenting, to the user, a second GUI comprising information associated with the existing customized design option and one or more interactive elements for specifying at least one user to which the existing customized design option should be shared;
receiving, from the user via the second GUI, a user interaction with the one or more interactive elements;
obtaining, based on the user interaction, at least one configuration profile associated with the at least one user; and
updating the at least one configuration profile to include an ID of a customized design charter associated with the existing customized design option

15. The method as claimed in claim 9, wherein the stylistic category is a color category.

16. The apparatus as claimed in claim 9, wherein the stylistic category is a typography category.

17. A non-transitory computer-readable recording medium having recorded thereon instructions executable by at least one processor to cause the at least one processor to perform a method comprising:
presenting, to a user, a first graphical user interface (GUI) comprising information of a stylistic category;
receiving, from the user via the first GUI, a user input for managing a customized design option associated with the stylistic category; and
managing the customized design option based on the user input

18. The non-transitory computer-readable recording medium as claimed in claim 17, wherein the presenting the first GUI comprises:
obtaining at least one source design charter associated with the stylistic category;
generating a listing including at least one design option predefined by the source design charter;
generating, based on the listing, the first GUI; and
providing the first GUI to a user terminal associated with the user.

19. The non-transitory computer-readable recording medium as claimed in claim 17, wherein the first GUI comprises a plurality of interactive elements, each of which is associated with an operation for managing the customized design option, wherein the user input comprises a user interaction with at least one interactive element of the plurality of interactive elements, and wherein the managing the customized design option comprises:
determining, based on the user input, the operation associated with the interactive element with which the user has interacted; and
performing the operation to manage the customized user input.

20. The non-transitory computer-readable recording medium as claimed in claim 19, wherein the managing the customized design option further comprises:
based on determining that the operation is a creation of a new customized design option, presenting, to the user, a second GUI comprising one or more interactive elements for specifying the configuration of the new customized design option;
receiving, from the user via the second GUI, a user interaction with the one or more interactive elements;
generating, based on the user interaction, a new customized design charter, wherein the new customized design charter defines the user-specified configuration of the new customized design option; and
updating, based on the new customized design charter, the first GUI to include information associated with the new customized design option.
